(19) United States
(12) Patent Application Publication
(10) Pub. No.: US 2022/0215267 A1
(43) Pub. Date: Jul. 7, 2022

(54) PROCESSES AND METHODS FOR ENABLING ARTIFICIAL GENERAL INTELLIGENCE CAPABLE OF FLEXIBLE CALCULATION, PREDICTION, PLANNING AND PROBLEM SOLVING WITH ARBITRARY AND UNSTRUCTURED DATA INPUTS AND OUTPUTS

(71) Applicant: Orbai Technologies, Inc., Santa Clara, CA (US)

(72) Inventor: Brent Leonard OSTER, Saint Lucia (HN)

(73) Assignee: Orbai Technologies, Inc., Santa Clara, CA (US)

(21) Appl. No.: 17/575,602

(22) Filed: Jan. 13, 2022

Related U.S. Application Data
(63) Continuation-in-part of application No. 16/437,838, filed on Jun. 11, 2019.
(60) Provisional application No. 63/138,058, filed on Jan. 15, 2021.
(60) Provisional application No. 62/687,179, filed on Jun. 19, 2018.
(60) Provisional application No. 62/809,297, filed on Feb. 22, 2019.

(51) Int. Cl. G06N 3/08; G06N 3/04

(52) U.S. Cl. CPC G06N 3/088; G06N 3/0454

(57) ABSTRACT

The present technology is an Artificial General Intelligence system and methods that will enable more advanced AI applications, with conversational speech, human-like cognition, and planning and interaction with the real world, learning to do all without supervision. It will find first use in smart devices, homes, and robotics, then in online professional services with an AGI at the core powering them. It makes use of neural networks.

### CROSS-REFERENCE TO RELATED APPLICATION

This application claims priority to currently pending U.S. patent application Ser. No. 16/437,838, titled “APPARATUS AND METHOD UTILIZING A PARAMETER GENOME CHARACTERIZING NEURAL NETWORK CONNECTIONS AS A BUILDING BLOCK TO CONSTRUCT A NEURAL NETWORK WITH FEEDFORWARD AND FEEDBACK PATHS,” and filed on Jun. 11, 2019, which claims priority to U.S. Provisional Patent Application No. 62/687,179, titled “CONTROLLING 3D CHARACTERS AND ANDROIDS,” filed Jun. 19, 2018, and to U.S. Provisional Patent Application No. 62/809,279, titled “METHODS FOR DEVELOPING ADVANCED ARTIFICIAL INTELLIGENCE USING SYNTHETIC NEURAL ARCHITECTURES DESIGNED WITH THE NEUROCAD TOOL SUITE,” filed Feb. 22, 2019. This application also claims priority to currently pending United States Provisional Patent Application, Application No. 63/138,058, titled “ARTIFICIAL GENERAL INTELLIGENCE IMPLEMENTED USING BICHNN AUTOENCODING AND HIERARCHICAL FRAGMENTED MEMORY,” filed Jan. 15, 2021. Each of the aforementioned entire applications is incorporated herein by reference in its entirety.

### TECHNICAL FIELD

This application relates in general to a system and method for providing artificial intelligence processing, and more specifically, to a system and method for providing artificial intelligence using neural networks and other computer hardware and software devices and methods to simulate human intelligence.

### BACKGROUND

Existing Artificial Intelligence currently is limited with regard to more advanced AI applications, with today's deep learning based systems having simple neural networks capable of only limited speech, with no human-like cognition, nor planning and interaction with the real world, not being able to learn without labelled data or supervision. This limitation causes slow adoption for such applications for use in smart devices, homes, and robotics, and also in online professional services, Solutions to many problems in AI remain unresolved as a result of the limitations of deep neural networks and deep learning.

Therefore, a need exists for a system and method for providing artificial intelligence using neural networks and other computer hardware and software devices and methods to simulate human intelligence according to the present technology. The present technology attempts to address existing limitations in a system and method for providing artificial intelligence using neural networks and other computer hardware and software devices and methods to simulate human intelligence.

### SUMMARY

In accordance with at least some embodiments of the present invention, the above and other problems are solved by providing artificial intelligence using neural networks and other computer hardware and software devices and methods to simulate human intelligence according to the principles and example embodiments disclosed herein.

In one embodiment, there is provided a system for providing artificial intelligence using neural networks and other computer hardware and software devices and methods to simulate human intelligence. The system comprising an artificial general intelligence system for computer simulations of Artificial General Intelligence (AGI) are able to operate on general inputs and outputs that do not have to be specifically formatted, nor labelled by humans and can consist of any alpha-numerical data stream, and 1D, 2D, and 3D formats of numerical data. The artificial general intelligence system includes a memory having instructions stored thereon, a short term memory, a long term memory, a HAN, a ROS-I network, the ROS-network having inhibitor signals, and a processor configured to execute the instructions on the memory to cause the artificial general intelligence system to auto-encode audio and sequential images of text characters into an Engram stream into the short-term memory, the Engram stream having one or more Engram segments, input the Engram segments into the HAN, reduce the Engram segments using the HAN into a basis set, the Engram segments comprising letters for writing, and phonemes and multiples for speech, transform the basis set into a set of basis set coordinates having basis vectors by convolution of one or more leaf Engrams with the basis vectors, feed backwards into the ROS-I network, back-driving the inhibitor signals, and output the inhibitor signals of the HAN/ROS-I network, organized hierarchically.

In another embodiment, there is provided a method for providing computer simulations of Artificial General Intelligence (AGI) system able to operate on general inputs and outputs that do not have to be specifically formatted, nor labelled by humans and can consist of any alpha-numerical data stream and 1D, 2D, and 3D formats of numerical data. The artificial general intelligence system includes a memory having instructions stored thereon, a short term memory, a long term memory, a HAN, a ROS-I network, the ROS-network having inhibitor signals, and a processor configured to execute instructions. The method auto-encodes audio and sequential images of text characters into an Engram stream into the short-term memory, the Engram stream having one or more Engram segments, inputs the Engram segments into the HAN, reduces the Engram segments using the HAN into a basis set, the Engram segments comprising letters for writing, and phonemes and multiples for speech, transforms the basis set into a set of basis set coordinates having basis vectors by convolution of one or more leaf Engrams with the basis vectors, feeds backwards the set of basis set coordinates into the ROS-I network, back-driving the inhibitor signals, and outputs the inhibitor signals of the HAN/ROS-I network, organized hierarchically.

In another embodiment, there is provided another method for providing computer simulations of Artificial General Intelligence (AGI) system able to operate on general inputs and outputs that do not have to be specifically formatted, nor labelled by humans and can consist of any alpha-numerical data stream. The artificial general intelligence system includes a memory having instructions stored thereon, a short term memory, a long term memory, a HAN, a ROS-I network, the ROS-network having inhibitor signals, and a processor configured to execute instructions. The method states by the AGI “Hello my name is Eta. What is your name?,” receives a response from a person as a result of the AGI statement, transforms audio from the microphone into a waveform that is fed into an autoencoder, transforms an input signal into an Engram then to basis coordinates, then to HTSIS, continuously updates by the AGI the predictions, using the person's speech up until that time, the prediction of what they will say after the AI speaks and the previous speech of the AI as the inputs to the predictor trained to generate the AI speech, generates by the AGI a branching dialog, deciding what to say next using the AI predictor, and using the predictor for the person to predict how they will respond to the AI response. the predictor looks ahead 2 moves essentially, predicts by the AGI what it should next say: “How can I help you” and that the person will respond with “I'm looking for ITEM1?’ or “I need a refund on ITEM2” or “Where is my ITEM2?” using the predictor trained on what the person will say generates by the AI As the person finishes speaking the best response to not only what the person just said, but that will lead into what they will say next. if the person said, “Hi AI, my name is Bob”, the AI will say something like “Nice to meet you Bob, are you looking for ITEM, or need to track or refund ITEM2?,” inputs by the AGI the phrase (encoded as a HTSIS) into the ROS-I network, up through the HAN, and out as a synthesized voice, created by training on a voice actor previously.

In another embodiment, there is provided method for providing computer simulations of Artificial General Intelligence (AGI) system able to operate on general inputs and outputs that do not have to be specifically formatted, nor labelled by humans and can consist of any alpha-numerical data stream. The artificial general intelligence system includes a memory having instructions stored thereon, a short term memory, a long term memory, a HAN, a ROS-I network, the ROS-network having inhibitor signals, and a processor configured to execute instructions. The method generates language becoming one or more inhibitor signals input to the ROS-I network, the ROS-I network having one or more ROS neurons, organized hierarchically, fires and transmits the inhibitor signals down inhibitor branches of the ROS-I network, That signal is modulates the inhibitor signals by HTSIS signals at each ROS neuron at each level of the hierarchy, outputs from the ROS-I sends basis coordinates to the HAN to be multiplied by basis set vectors, transforms the basis coordinates into Engrams by traversing backward up the HAN decodes audio or text data by the autoencoder and output from the top HAN layer.

In another embodiment, there is provided yet another method for artificial general intelligence that can simulate human intelligence, implemented by taking in any form of arbitrary Input, learning to transform it into an internal numerical format, then performing a plurality of numerical and other learned operations on the data in the internal format, then transforming them to the Output formats using the reciprocal process learned to transform it from inputs, all done unsupervised and without hand—labelled data

Another aspect of the present technology is starting with an autoencoder that learns to encode arbitrary input into a compact engram stream, and decode it again, with the engram stream sampled from a volume at the bottleneck of the autoencoder.

Another aspect of the present technology is where the engram stream is subdivided into segments in time, and the resulting engram segments are passed down a branching hierarchy that subdivides them by features till the leaf nodes of the hierarchy are each unique, sharing no common features, and thus form an orthogonal basis set of engram vectors.

Another aspect of the present technology is where for the engram segments we alternately perform principal component analysis to sort them along an axis by a specific feature, then auto-encode each cluster on each of the axes, removing the common features of the cluster, and passing the new encoded engrams down to perform principal component analysis to sort them along new axes by new features until the leaf nodes of the hierarchy are each unique and form an orthogonal basis set of engram vectors. This network is referred to as a Hierarchical Autoencoder Network or HAN network.

Another aspect of the present technology is using this basis set and the HAN network to transform from arbitrary Inputs to engram segments, then traversing the hierarchy to the leaf nodes and convolving the engram segment with the engram basis vectors of each leaf node to generate time-series basis coordinates, where each coordinate represents the convolution product of the engram segment and engram basis vector. This process is then done in reverse to transform basis coordinates to engram segments to arbitrary outputs.

Another aspect of the present technology is for doing computations on time-based memory narratives of numerical coefficient vectors, where a plurality of input vectors from given times (t) on a plurality of memory narratives are used as inputs to the computation to produce a plurality of output vectors to a plurality of memory narratives.

Another aspect of the present technology is for doing a predictor where a plurality of input basis coordinates from past times (t−N, . . . t−2, t−1, t) from a plurality of memory narratives are used as inputs, and a model trained on real past data is used to generate a plurality of output vectors, set in a future time.

Another aspect of the present technology is where the output from the predictor is subsequently used (along with input from memory narratives) as the input to said predictor, such that it is simulating reality to create a memory narrative, based on the model trained on reality in 7, basically dreaming without external input.

Another aspect of the present technology is for doing numerical and other operations where the operation consists of generating detailed sequential time-space outputs using an artificial neural network with a linear component that generates a propagating linear signal, and networks that branch off that linear component that transmit that signal down the branching network and modulate it with inhibitory signals.

Another aspect of the present technology is wherein a sequence of excitatory artificial neurons create a linear pulse chain. Each of these artificial neurons has a plurality of branching neural nets of inhibitory artificial neurons emanating from it, and the signal from the excitatory neurons propagates down them.

Another aspect of the present technology is where each inhibitory artificial neuron is controlled by a unique external input signal, that causes the inhibitory artificial neuron to modulate the signal from the artificial neurons above it in the hierarchy with the inhibitory signal.

Another aspect of the present technology is each inhibitory control signal can control large sections of the inhibitory networks downstream of its inhibitory artificial neuron, generating complex spatial-temporal signals when combined with the excitatory signal for sequential functions like motor control, language.

A method for solving problems where a beginning and goal (in basis coordinates) are known, and the method searches for an optimal memory narrative between them by starting at both the beginning and goal, and traversing memory narratives (optionally splitting and branching) till a branch from the beginning connects with one from the end. The method strengthens the connections found by the solution and iterates.

In another embodiment, there is provided yet another method of training the inhibitory signals by back-driving the network with the desired output, such as for motor control or language, then fitting the inhibitory signals to the signals that are back-driven through the network.

In another embodiment, there is provided yet another method for feeding the outputs of the excitatory-inhibitory network into the leaf nodes of the HAN network, as time-series basis coordinates to each leaf node, with the HAN network transforming those into engrams then output data in real-life format.

In another embodiment, there is provided yet another method for doing actuator and motor control for robotics and physical systems using the combined excitatory-inhibitory network and engram basis transformation network to provide input and output for the actuator control. It is trained by back-driving all the desired motions (physically or by simulation) through the Input to the engram basis set encoding scheme, and then using the basis coordinates to back-drive the excitatory-inhibitory system to train the desired motion controllers, in a manner similar to the human motor cortex.

In another embodiment, there is provided yet another method to train the combined systems to learn and use human language, both text and speech, by creating engram basis sets for letters and phonemes, inputting speech and text, then by using the basis coordinates transformed from input language train the excitatory-inhibitory network to produce sequences of language based on the training inputs. The output will be a set of trained inhibitory signals for each language sequence, and an inhibitory network that, in addition to specific sentences and phrases, forms basis sets for language spelling, grammar, and composition.

In another embodiment, there is provided yet another method for the AI to converse naturally with a human (by text or speech), by using a set of predictors, and input/output from/to the excitatory-inhibitory network and engram basis transformation network, as well as accessing past memory narratives. The first predictor guesses what the human will probably reply after the AI speaks next, with both this and what the human is currently saying being used by the second predictor to compute what the AI will actually say next, refining both predictions as the human is speaking. By knowing what the human is currently saying and predicting what they will say next, the AI can generate much more fluid and fluent language.

In another embodiment, there is provided yet another method for artificial general intelligence that can do cognitive tasks, control motor functions, and use language by combining all of the memory processing, prediction, dreaming, and problem solving methods, with the Input encoding and output decoding via basis sets and excitatory-inhibitory networks, to take in general inputs, convert them and store them in memory, do cognitive operations on them, and provide general output, all with human-like capabilities. By gathering the data from a human performance capture, we can use it to train a humanoid robot or 3D graphics character to speak, act, emote, and move like a real human.

In another embodiment, there is provided yet another method for completely specifying each of the components and systems, as well as the overall AGI configuration with a compact genome of information that can be expanded to generate instances of component or system, as well as the full AGI utilizing them, and a method for doing genetic algorithms on each component and system by training and testing N×N variants of it, selecting the best N against a selection criteria, then crossbreeding their genomes to create the next N×N variants testing them, and continuing till a threshold selection criteria is reached, doing this several iterations, then doing it on the whole AGI system to optimize it, and repeating this process as data is gathered to grow and refine the AGI.

In another embodiment, there is provided yet another method for artificial general intelligence that can simulate human intelligence, implemented by taking in any form of arbitrary input data. The method learns to transform the arbitrary input data into an internal numerical format, performs a plurality of numerical operations, the plurality of numerical operations comprises learned and neural network operations, on the arbitrary input data in the internal format, and transforms the arbitrary input data into output data having output formats using a reciprocal process learned to transform the output data from the arbitrary input data. all steps being done unsupervised and do not use hand-labeled data.

Another aspect of the present technology is the learning to transform step comprises utilizing an autoencoder that learns to encode the arbitrary Input data into a compact engram stream and decoding the compact engram stream, with the engram stream being sampled from a volume at a bottleneck of the autoencoder.

Another aspect of the present technology is the learning to transform step further comprises subdividing the engram stream into segments in time, and the resulting engram segments are passed down a branching hierarchy having leaf nodes, the branching hierarchy being a Hierarchical Autoencoder Network (HAN network), the HAN network subdividing the engram segments by features until the leaf nodes of the HAN network are each unique, sharing no common features, and forming an orthogonal basis set of engram vectors having a plurality of axes.

Another aspect of the present technology is the subdividing the engram stream step further comprises sorting the engram segments by alternately performing principal component analysis along an axis by a specific feature, autoencoding each cluster on each of the axes, thereby removing the common features of the cluster, and passing the new encoded engrams down the HAN network to perform principal component analysis to sort the new encoded engrams along new axes by new features until the leaf nodes of the HAN network are each unique and form an orthogonal basis set of engram vectors.

Another aspect of the present technology is the learning to transform step further comprises using the orthogonal basis set and the HAN network to transform from the arbitrary Input data to engram segments, traversing the hierarchy to the leaf nodes and convolving the engram segment with the engram basis vectors of each leaf node to generate time-series basis coordinates, where each coordinate represents the convolution product of the engram segment and engram basis vector, and processing the time-series basis coordinates in reverse transforming the basis coordinates of the engram segments into the arbitrary outputs.

Another aspect of the present technology is the performing a plurality of numerical and other learned operations step comprises performing computations on the time-series basis coordinates of numerical coefficient vectors, where a plurality of input vectors from given times (t) on a plurality of memory narratives are used as inputs to the computation to produce a plurality of output vectors to a plurality of memory narratives.

Another aspect of the present technology is the performing a plurality of numerical operations step further comprises performing a predictor where a plurality of input basis coordinates from past times (t−N, . . . t−2, t−1, t) from a plurality of the time-series basis coordinates are used as inputs, and a model trained on real past data is used to generate a plurality of output vectors, set in a future time.

Another aspect of the present technology is the performing a predictor step further comprises subsequently using the output from the predictor with input from the time-series basis coordinates as the input to said predictor, such that it is simulating reality to create output time-series basis coordinates based on the model.

Another aspect of the present technology is the learning to transform step further comprises training a ROS-Inhibitory neural network (ROS-I network), a detailed sequential time-space outputs, using an artificial neural network with a linear component that generates a propagating linear signal, and networks that branch off that linear component that transmit that signal down the branching network and modulate it with inhibitory signals.

Another aspect of the present technology is the training a ROS-I network step further comprises creating a sequence of excitatory artificial neurons to create a linear pulse chain, each of these excitatory artificial neurons has a plurality of branching neural nets of inhibitory artificial neurons emanating from it and propagating a signal from the excitatory neurons propagates down the branching neural networks.

Another aspect of the present technology is creating a sequence of excitatory artificial neurons step further comprises controlling by a unique external input signal each inhibitory artificial neuron causing the inhibitory artificial neuron to modulate the signal from the artificial neurons above it in the hierarchy with the inhibitory signal.

Another aspect of the present technology is learning to transform the arbitrary input data step further comprises controlling each inhibitory control signal to large sections of the inhibitory networks downstream of its inhibitory artificial neuron and generating complex spatial-temporal signals when combined with the excitatory signal for sequential functions like motor control, language.

Another aspect of the present technology is the training the ROS-I network step further comprises back-driving the complex spatial-temporal signals through the ROS-I network with the desired output, such as for motor control or language to train the inhibitory signals to reproduce the complex spatial-temporal signals.

Another aspect of the present technology is, the transforming the arbitrary input data further comprising feeding the outputs of the excitatory-inhibitory network into the leaf nodes of the HAN network, as time-series basis coordinates to each leaf node, with the HAN network transforming those into engrams then output data in real-life format.

In another embodiment, there is provided an artificial general intelligence system for computer simulations of Artificial General Intelligence (AGI) are able to operate on general inputs and outputs that do not have to be specifically formatted, nor labelled by humans and can consist of any alpha-numerical data stream, The artificial general intelligence system includes a memory having instructions stored thereon, a short term memory, a long term memory, a Hierarchical Autoencoder Network (HAN network), a ROS-Inhibitory neural network (ROS-I network), the ROS-I network having inhibitor signals, and a processor configured to execute the instructions on the memory. Executing these instructs cause the AGI system to learn to transform the arbitrary input data into an internal numerical format, perform a plurality of numerical and other learned operations on the arbitrary input data in the internal format, and transform the arbitrary input data into output data having output formats using a reciprocal process learned to transform the output data from the arbitrary input data. Transforming the arbitrary input data step further comprising feeding the outputs of the excitatory-inhibitory network into the leaf nodes of the HAN network, as time-series basis coordinates to each leaf node, with the HAN network transforming those into engrams then output data in real-life format, and wherein all steps being done unsupervised.

Another aspect of the present technology is the artificial general intelligence system executes instructions to perform the learning to transform the arbitrary input data step that further comprises instructions to utilize an autoencoder that learns to encode the arbitrary input data into a compact engram stream, decode the compact engram stream, with the engram stream being sampled from a volume at a bottleneck of the autoencoder, subdivide the engram stream into segments in time, and the resulting engram segments are passed down a branching hierarchy having leaf nodes, the branching hierarchy being a Hierarchical Autoencoder Network (HAN network), the HAN network subdividing the engram segments by features until the leaf nodes of the HAN network are each unique, sharing no common features, and forming an orthogonal basis set of engram vectors having a plurality of axes, sort the engram segments by alternately performing principal component analysis along an axis by a specific feature, auto-encode each cluster on each of the axes, thereby removing the common features of the cluster, pass the new encoded engrams down the HAN network to perform principal component analysis to sort the new encoded engrams along new axes by new features until the leaf nodes of the HAN network are each unique and form an orthogonal basis set of engram vectors, use the orthogonal basis set and the HAN network to transform from the arbitrary Input data to engram segments, traverse the hierarchy to the leaf nodes and convolving the engram segment with the engram basis vectors of each leaf node to generate time-series basis coordinates, where each coordinate represents the convolution product of the engram segment and engram basis vector, and train a ROS-Inhibitory neural network (ROS-I network), a detailed sequential time-space outputs, using an artificial neural network with a linear component that generates a propagating linear signal, and networks that branch off that linear component that transmit that signal down the branching network and modulate it with inhibitory signals.

Another aspect of the present technology is the artificial general intelligence system executes instructions to perform a plurality of numerical operations, the plurality of numerical operations comprises learned and neural network operations, on the arbitrary input data in the internal format comprise process the time-series basis coordinates in reverse to transforming the basis coordinates of the engram segments into the arbitrary outputs, performing computations on the time-series basis coordinates of numerical coefficient vectors, where a plurality of input vectors from given times (t) on a plurality of memory narratives are used as inputs to the computation to produce a plurality of output vectors to a plurality of memory narratives, subsequently use the output from the predictor with input from the time-series basis coordinates as the input to said predictor, such that it is simulating reality to create output time-series basis coordinates based on the model, creating a sequence of excitatory artificial neurons to create a linear pulse chain, each of these excitatory artificial neurons has a plurality of branching neural nets of inhibitory artificial neurons emanating from it, and propagating a signal from the excitatory neurons propagates down the branching neural networks.

Another embodiment provides a non-transitory computer-readable recording medium in an artificial general intelligence system, the artificial general intelligence system includes a memory having instructions stored thereon, a short term memory, a long term memory, a HAN network, a ROS-I network, the ROS-network having inhibitor signals, and a processor configured to execute the instructions on the memory to cause the artificial general intelligence system, the non-transitory computer-readable recording medium storing one or more programs which when executed by a the artificial general intelligence system performs steps of the methods described above.

Another embodiment provides a non-transitory computer-readable recording medium in an artificial general intelligence system, the artificial general intelligence system includes a memory having instructions stored thereon, a short term memory, a long term memory, a HAN network, a ROS-I network, the ROS-network having inhibitor signals, and a processor configured to execute the instructions on the memory to cause the artificial general intelligence system, the non-transitory computer-readable recording medium storing one or more programs which when executed by a the artificial general intelligence system performs steps of the methods described above.

The foregoing has outlined rather broadly the features and technical advantages of the present technology in order that the detailed description of the invention present echnology that follows may be better understood. Additional features and advantages of the present technology will be described hereinafter that form the subject of the claims of the present technology.

It should be appreciated by those skilled in the art that the conception and specific embodiment(s) disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE FIGURES

FIG. 1 illustrates a system that provides for Artificial General Intelligence (AGI) within a computing system according to one aspect of the present technology.

FIG. 2a is a block diagram illustrating an exemplary hardware architecture of a computing device.

FIG. 2b is a block diagram illustrating an exemplary logical architecture for a client device.

FIG. 2c is a block diagram showing an exemplary architectural arrangement of clients, servers, and external services.

FIG. 2d is another block diagram illustrating an exemplary hardware architecture of a computing device.

FIG. 3 illustrates a flowchart corresponding to a method performed by software components of a system for providing artificial intelligence using neural networks and other computer hardware and software devices and methods to simulate human intelligence according to some embodiments of the present technology.

FIG. 4a illustrates using cross-breeding of genomes in genetic algorithms to design and optimize systems and components for providing artificial intelligence using neural networks and other computer hardware and software devices and methods to simulate human intelligence according to some embodiments of the present technology.

FIG. 4b illustrates the smoothness and continuity requirements for the generation of new genomes for providing artificial intelligence using neural networks and other computer hardware and software devices and methods to simulate human intelligence according to some embodiments of the present technology.

FIG. 5 illustrates an autoencoding process 500 for providing artificial intelligence using neural networks and other computer hardware and software devices and methods to simulate human intelligence according to some embodiments of the present technology. to a compact engram for encoding and decoding inputs and outputs for artificial intelligence using neural networks and other computer hardware and software devices and methods to simulate human intelligence according to some embodiments of the present technology.

FIG. 6 illustrates an autoencoding process 600 of video data for providing artificial intelligence using neural networks and other computer hardware and software devices and methods to simulate human intelligence according to some embodiments of the present technology.

FIG. 7 illustrates using a Gaussian or other function with a localized span in time convolved with an engram stream to sample intervals or segments 700 of engram stream data for providing artificial intelligence using neural networks and other computer hardware and software devices and methods to simulate human intelligence according to some embodiments of the present technology.

FIG. 8 illustrates using a step function or other function with a localized span in time convolved with an engram stream to sample intervals or segments 800 of engram stream data for providing artificial intelligence using neural networks and other computer hardware and software devices and methods to simulate human intelligence according to some embodiments of the present technology.

FIG. 9 illustrates an orthogonal basis set of such volumes of engram stream data for providing artificial intelligence using neural networks and other computer hardware and software devices and methods to simulate human intelligence according to some embodiments of the present technology.

FIG. 10 illustrates an example of basis vectors and basis coordinates for representing arbitrary data with a basis set that spans the domain of the data for providing artificial intelligence using neural networks and other computer hardware and software devices and methods to simulate human intelligence according to some embodiments of the present technology.

FIG. 11 illustrates an example of the time-series set of basis coordinates for providing artificial intelligence using neural networks and other computer hardware and software devices and methods to simulate human intelligence according to some embodiments of the present technology.

FIG. 12 illustrates that a human brain has cortical columns that are analogous structures to the autoencoder technology for providing artificial intelligence using neural networks and other computer hardware and software devices and methods to simulate human intelligence according to some embodiments of the present technology.

FIG. 13 illustrates that a human brain has thalamocortical radiations that are analogous structures to our HAN network for providing artificial intelligence using neural networks and other computer hardware and software devices and methods to simulate human intelligence according to some embodiments of the present technology.

FIG. 14 illustrates that a human brain has analogous structures for providing artificial intelligence using neural networks and other computer hardware and software devices and methods to simulate human intelligence according to the present technology.

FIG. 15a illustrates an example of an orthogonal basis set of Engram vectors for providing artificial intelligence using neural networks and other computer hardware and software devices and methods to simulate human intelligence according to some embodiments of the present technology.

FIG. 15b illustrates a flowchart of the generation of an orthogonal basis set.

FIG. 15c illustrates a sequence that decodes from basis set engrams back to real-world outputs, where the prior diagram describes the encoding.

FIG. 16 illustrates an example HAN network for providing artificial intelligence using neural networks and other computer hardware and software devices and methods to simulate human intelligence according to some embodiments of the present technology.

FIG. 17 illustrates an example translating time-series basis coordinates for providing artificial intelligence using neural networks and other computer hardware and software devices and methods to simulate human intelligence according to the present technology.

FIG. 18 illustrates an example organization of language time-series narratives for providing artificial intelligence using neural networks and other computer hardware and software devices and methods to simulate human intelligence according to some embodiments of the present technology.

FIG. 19 illustrates an example HAN encoding network for providing artificial intelligence using neural networks and other computer hardware and software devices and methods to simulate human intelligence according to some embodiments of the present technology.

FIG. 20a-b illustrate a speech-based example use of a HAN encoding network for providing artificial intelligence using neural networks and other computer hardware and software devices and methods to simulate human intelligence according to some embodiments of the present technology.

FIG. 21 illustrates an example use of a HAN encoding network for providing artificial intelligence using neural networks and other computer hardware and software devices and methods to simulate human intelligence according to some embodiments of the present technology.

FIG. 22 adds a computational method for providing artificial intelligence using neural networks and other computer hardware and software devices and methods to simulate human intelligence according to some embodiments of the present technology by performing computations on the transformed mathematical representations of the inputs and outputs.

FIG. 23 illustrates a method for doing computations by sampling values from a plurality of intervals in time in past recorded data according to the present technology by predicting the future of a timeline of data.

FIG. 24 illustrates another example of a problem addressable by the AGI system 100 according to some embodiments of the present technology.

FIG. 25 illustrates a method for the AI to converse naturally with a human, by training a set of dreaming predictors of FIG. 23 evolved, to learn human language by training and evolution on a plurality of human conversations according to some embodiments of the present technology.

FIGS. 26a-d illustrates flowcharts corresponding to a various methods performed by software components of a system for providing artificial intelligence using neural networks and other computer hardware and software devices and methods to simulate human intelligence to some embodiments of the present technology.

FIG. 27 illustrates a usage of a system for providing artificial intelligence using neural networks and other computer hardware and software devices and methods to simulate human intelligence according to some embodiments of the present technology.

FIG. 28 illustrates the above sequence of operations 2800 to use a predictor 2300 that predicts the sequence of hearings in the proceeding according to some embodiments of the present technology.

FIG. 29 illustrates an example of legal document processing by a system for providing artificial intelligence using neural networks and other computer hardware and software devices and methods to simulate human intelligence according to some embodiments of the present technology.

FIG. 30 illustrates how to use the HAN in combination with the ROS-I to learn whole documents, is disclosed using their paragraph rules of composition, sentence grammar, and spelling according to some embodiments of the present technology.

### DETAILED DESCRIPTION OF THE PREFERRED EMBODIMENTS=

This application relates in general to a system and method for providing artificial intelligence processing, and more specifically, to a system and method for providing artificial intelligence using neural networks and other computer hardware and software devices and methods to simulate human intelligence according to embodiments of the present technology.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present technology, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact but may be approximated and/or larger or smaller, as desired, reflecting tolerances, conversion factors, rounding off, measurement error and the like, and other factors known to those of skill. Further, unless otherwise stated, the term “about” shall expressly include “exactly.”

The terms “subject” and “user” refer to an entity, e.g. a human, using a system and method for providing artificial intelligence using neural networks and other computer hardware and software devices and methods to simulate human intelligence according to the present technology including any software or smart device application(s) associated with the technology. The term user herein refers to one or more users.

The term “connection” refers to connecting any hardware or software component as defined below by any means, including but not limited to, a wired connection(s) using any type of wire or cable for example, including but not limited to, coaxial cable(s), fiberoptic cable(s), and ethernet cable(s) or a wireless connection(s) using any type of frequency/frequencies or radio wave(s), as well as software means of connecting two software structures with an intermediary software structure with indices or pointers between them. Some examples are included below in this application.

The term “invention” or “present invention”, “present technology” refers to the technology being applied for via the patent application with the title “Processes and Methods for Enabling Artificial General Intelligence Capable of Flexible Calculation, Prediction, Planning and Problem Solving With Arbitrary and Unstructured Data Inputs and Outputs.” These terms may be used interchangeably with processes and methods.

The terms “communicate”, or “communication” refer to any component(s) connecting with any other component(s) in any combination for the purpose of the connected components to communicate and/or transfer data to and from any components and/or control any settings.

The term “Input/Output” refers to any alphanumeric, or 1D, 2D, 3D data with spatial and/or temporal vector dimensions.

The term “Autoencoder” refers to a method for compressing and encoding Input then decompressing and decoding it back to the original data, with the encoding and decoding methods and the encoded format all learned unsupervised at runtime.

The term “Engram Stream” refers to compressed Input, in a 3D volume that evolves in time.

The term “Engram Segment” refers to sections of an engram stream cut into discrete time intervals.

The term “Hierarchical Autoencoder Network” (abbreviated as HAN) refers to the hierarchical, branching network of engram segments that are progressively subdivided with the engram going down each branch with selected specific features different from the other.

The term “Engram Basis Set” refers to the leaf-node engrams in the HAN, where each one is unique, and they are orthogonal to each other.

The term “Basis Coordinates” refers to the output of convolving an input engram with the leaf-node engrams in the engram basis set.

The term “Memory Narratives” refers to time-series basis coordinates (TSBCs)=basis coordinates with an additional temporal component.

The term “Hierarchical Time Basis Coordinates (HTBSCs)” refers to TSBCs converted to a hierarchical representation by a ROS excitatory/inhibitory network.

The term “Spiking Neural Network (SNN) refers to a connected network of simulated neurons in which the neurons have a mathematical model which simulates combining the inputs from its dendritic (input) connections, doing a computation based on them, and when computed, to emit spikes of current onto the SNN's axonal output, which then branch and connect to other neuron's dendrites via simulated synapses. The defining characteristic of a SNN is that the spikes of current move along the axons and dendrites in time, giving it spatial-temporal computing capabilities.

The terms “training”, “learning”, and “unsupervised learning” all refer to unsupervised learning accomplished by the neural net automatically strengthening and weakening synaptic connections by an internal process similar to the biological Hebbian principle, by strengthening synapses when both of the neurons they connect fire within an interval specified in the genome by the user.

The “training”, “learning”, and “unsupervised learning,” plus the terms “genetic algorithms”, “evolve”, and “evolution” all refer to Hebbian learning being used in training on pre-recorded data and real-time data, and in addition describe the use of genetic algorithms for designing and evolving these spiking neural networks (SNN), using genetic algorithms and crossbreeding operators on the compact genomes that are expanded to the full neural networks to be trained, then evaluated according to specified criteria, to see if they will be crossbred for the next generation, repeating until a SNN that meets the specified criteria is evolved.

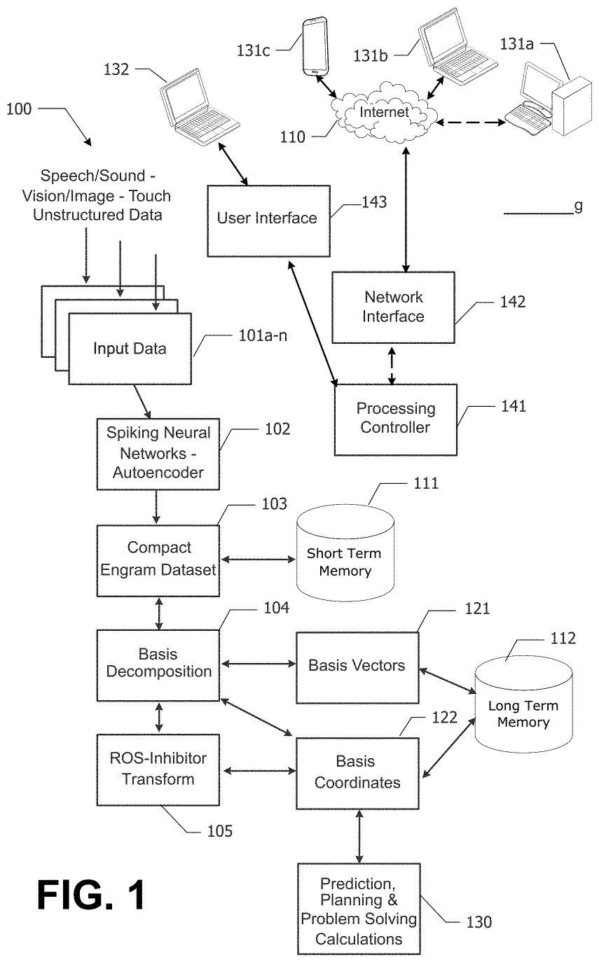

In general, the present disclosure relates to a system and method for providing artificial intelligence processing, and more specifically, to a system and method for providing artificial intelligence using neural networks and other computer hardware and software devices and methods to simulate human intelligence. To better understand embodiments of the present technology, FIG. 1 illustrates a system that provides for Artificial General Intelligence (AGI) within a computing system.

AGI methods and processes for computer simulations of Artificial General Intelligence (AGI) are able to operate on general inputs and outputs that do not have to be specifically formatted, nor labelled by humans and can consist of any alpha-numerical data stream, 1D, 2D, and 3D temporal-spatial inputs, and others. The AGI is capable of doing general operations on them that emulate human intelligence, such as interpolation, extrapolation, prediction, planning, estimation, and using guessing and intuition to solve problems with sparse data. These methods will not require specific coding, but rather can be learned unsupervised from the data by the AGI and its internal components using spiking neural networks. Using these methods, the AGI would reduce the external data to an internal format that computers can more easily understand, be able to do math, linear algebra, supercomputing, and use databases, yet still plan, predict, estimate, and dream like a human, then be able to convert the results back to human understandable form. All details of these methods will be further elaborated on in the full description of the present technology, and the paragraph numbers of those descriptions noted below.

The AGI system 100 accepts unstructured input data 101a-n into a spiking neural network encoder 102 for processing into a compact Engram dataset 103. The input data 102 may consist of unstructured speech and sound data, unstructured vision and image data, and unstructured touch stimulation data among other possible sources of data such as alphanumeric data, 1D, 2D, and 3D vectors of data.

The compact Engram dataset 103 may be stored into short-term memory 111 for later use. The short-term memory 111 may comprise storage devices such as solid-state drives, random access memory, and disk drives to maintain the data for as long as they may be needed. The compact Engram dataset 103 also may be stored into organized data structures such as file systems and databases as needed.

The compact Engram dataset 103 may then be processed by a basis decomposer 104 that accepts a compact Engram dataset 103, either directly from the spiking neural network encoder 102 or from short-term memory 111 to generate basis vector data 121 and basis coordinates 122. The basis vector data 121 and the basis coordinates 122 may be stored into long-term memory 112 for use as the AI system is trained and learns. The long-term memory 112 may comprise storage devices such as solid-state drives, random access memory, and disk drives to maintain the basis vector data 121 and the basis coordinates 122 for as long as they may be needed. The basis vector data 121 and the basis coordinates 122 may also be stored into organized data structures such as file systems and databases as needed.

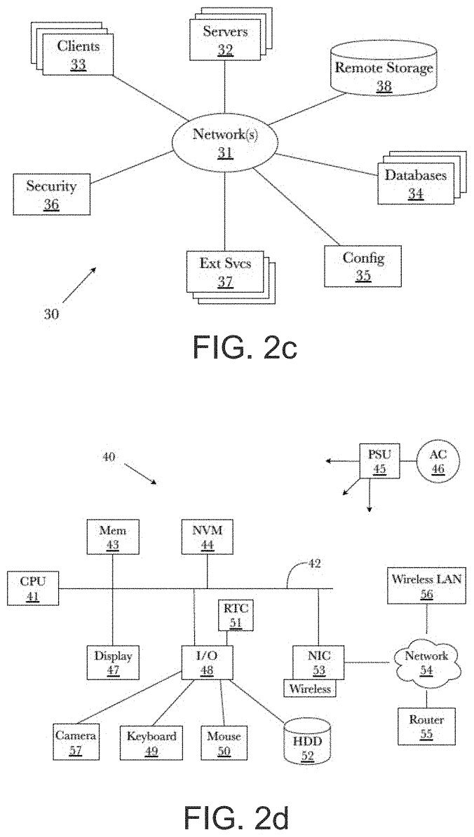

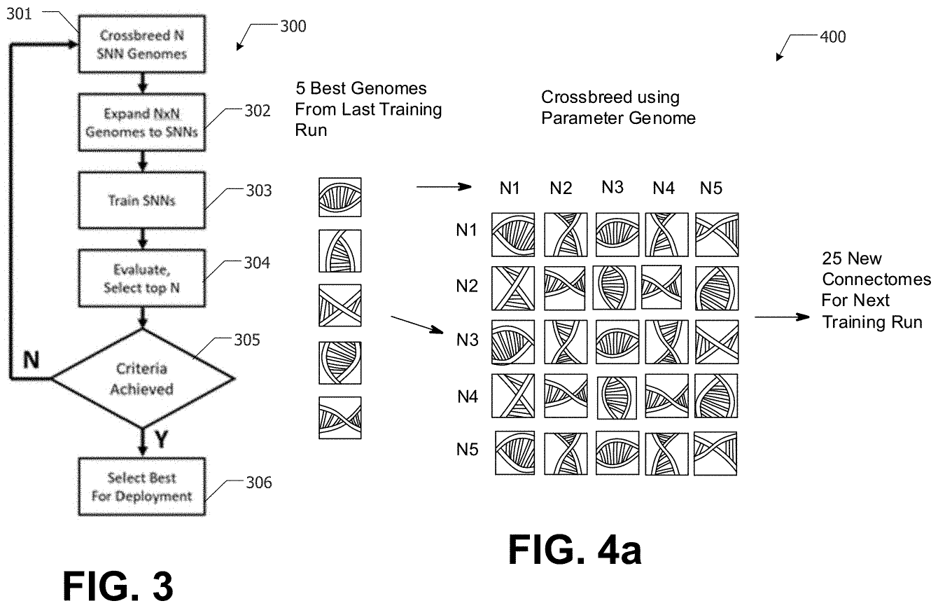

The input system 101a-n would learn to auto-encode any time domain input, including alphanumeric streams, 1D, 2D, and 3D inputs, using the SNN autoencoders 102 to encode them into compact engram streams 103, and write these engram streams 103 to short-term memory 111. Operation of the SNN autoencoder 102 is disclosed below in more detail in reference to FIGS. 3-4.

After a predetermined duration (as specified by a variable set by the user in the initial design and subsequent genetic algorithm modifications) of short-term memory 111 has been recorded, it is batch processed by cutting it into segments by convolving it with a time-domain function like a Gaussian or unit step function centered at time t and advancing t by dt each time such that the segments have a predetermined overlap.

Processing the engram segments 103 using a hierarchical sorting architecture of autoencoders 101 and PCA operations, then convolving engram segments 103 with the vector basis sets 121 at the leaf nodes to transform them to a set of basis coefficients 122. Storing basis coefficients 122 encoded from inputs 101a-n (or those computed internally) converted into time-series basis coordinates 122a-n in memory.

Doing mathematical, neural net, and other operations between sets of basis coefficients.

Using neural net constructs such as predictors, solvers, and dreamers to do operations on time-series of basis coordinates.

Use ROS excitatory/inhibitory networks to convert TSBCs to Hierarchical Time Basis Coordinates (HTBSCs) and vice versa. Transforming the internal basis coefficient narrative representations back to Engrams using the autoencoder hierarchy, then back to real-world outputs using the autoencoders.

With these developments, aspects of the present technology take the first steps toward AGI that can perceive the real world, reduce those perceptions to an internal format that computers can understand, yet still plan, think, and dream like a human, then convert the results back to human understandable form, and even converse fluently using human language, enabling online interfaces and services that can interact much more like a person.

Additional details regarding the definition and use of spiking neural networks may be found in commonly assigned U.S. patent application Ser. No. 16/437,838 filed Jun. 11, 2019, that has been incorporated by reference herein.

As noted above, at least some embodiments of the present technology also may be deployed for individual use via an application which can be on a personal computing device, for example smart phone computer or tablet, as embodiments of this technology may help people who cannot read or write but can speak a native language fluently. Mobile application developers may include the embodiments of the present technology within their applications as a mechanism to obtain feedback from users of these mobile applications.

The embodiments of the technology comprise an AGI system 100 to interact with users 131a-c, 132. Users 131-132 interact with the AGI system 100 either directly to a user interface 143 from a connected device 132 or to a network interface 142 from a network device 131a-c communicating over the Internet 110. The AGI system 100 may be hosted on various processing devices with the control of the AGI system 100 being managed by a control process 141 including an operating system or similar scheduling and control process.

The artificial intelligence processing system 100 may use any type of network such as a single network, multiple networks of a same type, or multiple networks of different types which may include one or more of a direct connection between devices, including but not limited to a local area network (LAN), a wide area network (WAN) (for example, the Internet), a metropolitan area network (MAN), a wireless network (for example, a general packet radio service (GPRS) network), a long term evolution (LTE) network, a telephone network (for example, a Public Switched Telephone Network or a cellular network), a subset of the Internet, an ad hoc network, a fiber optic network (for example, a fiber optic service (often known as FiOS) network), or any combination of the above networks.

Smart devices mentioned herein the present application also may use one or more sensors to receive or send signals, such as wireless signals Bluetooth™, wireless fidelity, infrared, Wi-Fi, or LTE. Any smart device mentioned in this application may be connected to any other component or smart device via wired communications (e.g., conductive wire, coaxial cable, fiber optic cable, ethernet cable, twisted pair cable, transmission line, waveguide, etc.), or a combination of wired and wireless communications. The present technology's method and/or system may use a single server device or a collection of multiple server devices and/or computer systems.

The systems and methods described above, may be implemented in many different forms of applications, software, firmware, and hardware. The actual software or smart device application codes or specialized control software, hardware or smart device application(s) used to implement the present technology's systems and methods is not limiting of the implementation. Thus, the operation and behavior of the systems and methods are described without reference to the specific software or firmware code. Software, smart device application(s), firmware, and control hardware can be designed to implement the systems and methods based on the description herein.

While all of the above functions are described to be provided to users via a mobile application on a smartphone, one of ordinary skill will recognize that any computing device including tablets, laptops, and general-purpose computing devices may be used as well. In at least one embodiment, all of the services described herein are provided using web pages being accessed from the web server using a web browser such as Safari™, Firefox™, Chrome™, DuckDuckGo™, and the like. All of the screen examples described herein show user interface elements that provide the functionality of the present technology. The arrangement, organization, presentation, and use of particular user input/output (I/O) elements including hyperlinks, buttons, text fields, scrolling lists, and similar I/O elements, are shown herein for example embodiments only to more easily convey the features of the present technology. The scope of the present invention should not be interpreted as being limited by any of these elements unless expressly recited within the attached claims.

For the purposes of the example embodiment of FIG. 1, various functions are shown to be performed on different programmable computing devices that communicate with each other over the Internet 110. These computing devices may include smartphones 131a, laptop computers 131b, tablets 131c, and similar devices so long as the disclosed functionality of the mobile application described herein is supported by the particular computing device. One of ordinary skill will recognize that this functionality is grouped as shown in the embodiment for clarity of description. Two or more of the processing functions may be combined onto a single processing machine. Additionally, it may be possible to move a subset of processing from one of the processing systems shown here and retain the functionality of the present technology. The attached claims recite any required combination of functionality onto a single machine, if required, and all example embodiments are for descriptive purposes.

For the above devices that are in communication with each other, some, or all of them need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects, and more fully illustrate one or more aspects. Similarly, although process steps, method steps, algorithms or the like may be described in a sequential order, such processes, methods, and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example, an end-user computer system, a client computer, a network server or other server system, a mobile computing device (e.g., tablet computing device, mobile phone, smartphone, laptop or other appropriate computing device), a consumer electronic device, a music player or any other suitable electronic device, router, switch or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines or other appropriate virtual environments).

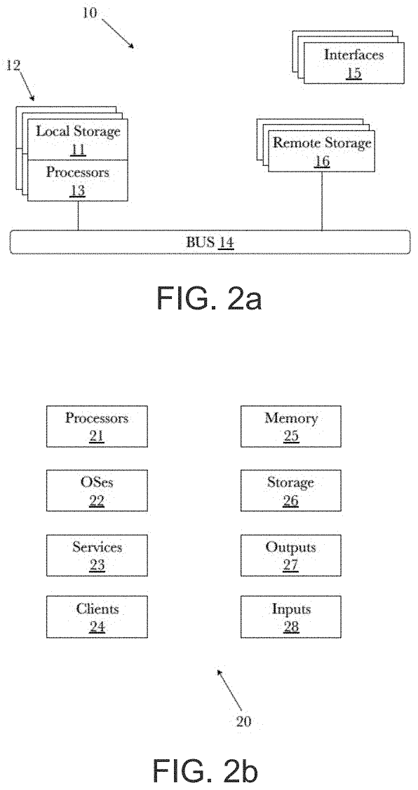

Referring now to FIG. 2a, there is a block diagram depicting an exemplary computing device 10 suitable for implementing at least a portion of the features or functionalities disclosed herein. The computing device 10 may be, for example, any one of the computing machines listed in the previous paragraph, or indeed any other electronic device capable of executing software- or hardware-based instructions according to one or more programs stored in memory. The computing device 10 may be configured to communicate with a plurality of other computing devices, such as clients or servers, over communications networks such as a wide area network, a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more buses 14 (such as a peripheral component interconnect (PCI) bus). When acting under the control of appropriate software or firmware, the CPU 12 may be responsible for implementing specific functions associated with the functions of a specifically configured computing device or machine. For example, in at least one aspect, a computing device 10 may be configured or designed to function as a server system utilizing a CPU 12, local memory 11 and/or remote memory 16, and interface(s) 15. In at least one aspect, a CPU 12 may be caused to perform one or more of the different types of functions and/or operations under the control of software modules or components, which for example, may include an operating system and any appropriate applications software, drivers, and the like.

A CPU 12 may include one or more processors 13 such as for example, a processor from one of the Intel, ARM, Qualcomm, and AMD families of microprocessors. In some aspect, processors 13 may include specially designed hardware such as application-specific integrated circuits (ASICs), electrically erasable programmable read-only memories (EEPROMs), field-programmable gate arrays (FPGAs), and so forth, for controlling operations of a computing device 10. In a particular aspect, a local memory 11 (such as non-volatile random access memory (RAM) and/or read-only memory (ROM), including for example, one or more levels of cached memory) may also form part of a CPU 12. However, there are many different ways in which memory may be coupled to a system 10. Memory 11 may be used for a variety of purposes such as, for example, caching and/or storing data, programming instructions, and the like. It should be further appreciated that a CPU 12 may be one of a variety of system-on-a-chip-(SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may, for example, support other peripherals used with a computing device 10. Among the interfaces that may be provided are ethernet interfaces, frame relay interfaces, cable interfaces, DSL interfaces, token ring interfaces, graphics interfaces, and the like. In addition, various types of interfaces may be provided such as, for example, universal serial bus (USB), serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast ethernet interfaces, gigabit ethernet interfaces, serial ATA (SATA) or external SATA (ESATA) interfaces, high-definition multimedia interfaces (HDMI), digital visual interfaces (DVI), analog or digital audio interfaces, asynchronous transfer mode (ATM) interfaces, high-speed serial interfaces (HSSI), point of sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity AN hardware interfaces) and, in some instances, volatile and/or non-volatile memory (e.g., RAM).

Although the system shown in FIG. 2a illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and a server system (such as a server system described in more detail below).

Regardless of network device configuration, the system of an aspect may employ one or more memories or memory modules (for example, remote memory block 16 and local memory 11) configured to store data, program instructions for the general-purpose network operations or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information or any other specific or generic non-program information described herein.

Because such information and program instructions may be employed to implement one or more systems or methods described herein, at least some network device aspects may include non-transitory machine-readable storage media, which, for example, may be configured or designed to store program instructions, state information, and the like for performing various operations described herein. Examples of such non-transitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device) or they may be removable such as swappable flash memory modules (such as “thumb drives” or other removable media designed for rapidly exchanging physical storage devices), “hot-swappable” hard disk drives or solid state drives, removable optical storage disks, or other such removable media, and that such integral and removable storage media may be utilized interchangeably. Examples of program instructions include both object code, such as may be produced by a compiler, machine code, such as may be produced by an assembler or a linker, byte code, such as may be generated by for example by a JAVA™ compiler and may be executed using a JAVA™ virtual machine or equivalent, or files containing higher level code that may be executed by the computer using an interpreter (for example, scripts written in Python™, Perl™, Ruby™ Groovy™, or any other scripting language).

In some aspect, systems may be implemented on a standalone computing system. Referring now to FIG. 2b, a block diagram is depicting a typical exemplary architecture of one or more aspects or components thereof on a standalone computing system. A computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the LINUX™ operating system, ANDROID™ operating system, or the like. In many cases, one or more shared services 23 may be operable in system 20 and may be useful for providing common services to client applications 24. Services 23 may, for example, be WINDOWS™ services, user-space common services in a LINUX™ environment or any other type of common service architecture used with an operating system 22. Input devices 28 may be of any type suitable for receiving user input including, for example, a keyboard, touchscreen, microphone (for example, for voice input), mouse, touchpad, trackball or any combination thereof. Output devices 27 may be of any type suitable for providing output to one or more users, whether remote or local to system 20, and may include, for example, one or more screens for visual output, speakers, printers, or any combination thereof. Memory 25 may be RAM having any structure and architecture known in the art for use by processors 21, for example to run software. Storage devices 26 may be any magnetic, optical, mechanical, memristor or electrical storage device for storage of data in digital form (such as those described above, referring to FIG. 2a). Examples of storage devices 26 include flash memory, magnetic hard drive, CD-ROM, and the like.

In some aspects, systems may be implemented on a distributed computing network, such as one having any number of clients and/or servers. Referring now to FIG. 2c, a block diagram is depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 2b. In addition, any number of servers 32 may be provided for handling requests received from one or more clients 33. Clients 33 and servers 32 may communicate with one another via one or more electronic networks 31, which may be in various aspects any Internet, wide area network, mobile telephony network (such as CDMA or GSM cellular networks), wireless network (such as WiFi, WiMAX, LTE, and so forth) or local area network (or indeed any network topology known in the art; the aspect does not prefer any one network topology over another). Networks 31 may be implemented using any known network protocols, including, for example, wired and/or wireless protocols.

In addition, in some aspect, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself. For example, in one aspect where client applications 24 are implemented on a smartphone or other electronic device, client applications 24 may obtain information stored on a server system 32 in the Cloud or on an external service 37 deployed on one or more of a particular enterprise's or user's premises. In addition to local storage on servers 32, remote storage 38 may be accessible through the network(s) 31.

In some aspects, clients 33 or servers 32 (or both) may make use of one or more specialized services or appliances that may be deployed locally or remotely across one or more networks 31. For example, one or more databases 34 in either local or remote storage 38 may be used or referred to by one or more aspects. It should be understood by one having ordinary skill in the art that databases in storage 34 may be arranged in a wide variety of architectures and use a wide variety of data access and manipulation means. For example, in various aspects one or more databases in storage 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system or a logical database within an overall database management system. Unless a specific meaning is specified for a given use of the term “database,” it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web system. It should be understood by one having ordinary skill in the art that any configuration or security subsystems known in the art now or in the future may be used in conjunction with aspects without limitation, unless a specific security 36 or configuration system 35 or approach is required by the description of any specific aspect.

FIG. 2d shows an exemplary overview of a computer system 40 as may be used in any of the various locations throughout the system. It is exemplary of any computer that may execute code to process data. Various modifications and changes may be made to a computer system 40 without departing from the broader scope of the system and method disclosed herein. A CPU 41 is connected to bus 42, to which bus is also connected to memory 43, non-volatile memory 44, display 47, I/O unit 48, and network interface card (NIC) 53. An I/O unit 48 may, typically, be connected to peripherals such as a keyboard 49, pointing device 50, hard disk 52, real-time clock 51, camera 57, and other peripheral devices. A NIC 53 connects to a network 54, which may be the Internet or a local network, which local network may or may not have connections to the Internet. The system may be connected to other computing devices through the network via a router 55, wireless local area network 56 or any other network connection. Also shown as part of a system 40 is a power supply unit 45 connected, in this example, to a main alternating current (AC) supply 46. Not shown are batteries that could be present and many other devices and modifications that are well known, but are not applicable to, the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles or other integrated hardware devices).

In various aspects, functionality for implementing systems or methods of various aspects may be distributed among any number of client and/or server components. For example, various software modules may be implemented for performing various functions in connection with the system of any particular aspect, and such modules may be implemented to run on server and/or client components.

FIG. 3 illustrates a flowchart corresponding to a method performed by software components of a system for providing artificial intelligence using neural networks and other computer hardware and software devices and methods to simulate human intelligence according to the present technology. The present technology uses evolutionary methods for designing and evolving spiking neural networks (SNN), using genetic algorithms operating on the compact genomes that are expanded to the full neural networks to be trained, then evaluated according to specified criteria, to see if they will be crossbred for the next generation, repeating until a SNN that meets the specified criteria is evolved.

The method 300, in step 301, N SNN genomes are crossbred and expanded into N×N genomes to the SNNs in step 302.

The SNNs are trained in Step 303.

The result of the training is evaluated to select a set of the top N genomes in step 304.

Test step 305 determines whether a specified criteria has been met, such as taking the RMS of the difference between all the values in the desired output and the actual output values, and if it is not met, the process 300 returns to step 301 for further processing. When the specified criteria are met, the process 300 selects the best genomes for deployment in step 306.

FIG. 4a illustrates using cross-breeding of genomes in genetic algorithms to design and optimize systems and components for providing artificial intelligence using neural networks and other computer hardware and software devices and methods to simulate human intelligence according to the present technology. Methods for designing and evolving spiking neural networks (SNNs), which consist of computer simulated (assumed from here forward) artificial neurons connected by axons and dendrites with a synapse between each axon and dendrite. Spikes of current are transmitted from the neuron, out along the axon, then are absorbed at the synapse and processed. The synapse may then, depending on the computation, transmit a spike out along the dendrite and to the neuron. Each time the neurons on either side of a synapse fire in sequence, that synapse is ‘strengthened’ and the likelihood of transmitting a spike increases. The spikes move in time and space and this temporal circuitry is key to the SNN's functionality and utility. Axons and dendrites can branch, with the outgoing spikes splitting and being amplified as they go out along the branches of the axon. Likewise, signals can combine as dendrites merge before entering the neuron. The incoming signals to a neuron can be excitatory or inhibitory, adding or subtracting charge from the neurons. Neurons can then integrate the incoming signals or differentiate them, or other operations, then emit spikes based on their internal computation.

The present technology uses mathematical models for the neurons and synapses that integrate, differentiate, or otherwise compute the contribution of the incoming charges and compute an output based on the mathematical model over time. The present technology moves the discrete spikes of current along the axons and dendrites at a constant speed, checking for when they enter a synapse or a neuron. Sensory inputs are translated to spikes of current into sensory neurons.

FIG. 4b illustrates the smoothness and continuity requirements for the generation of new genomes for providing artificial intelligence using neural networks and other computer hardware and software devices and methods to simulate human intelligence. FIG. 4b shows a neural network 450 used by the AGI system 100 herein. Each neural network connectome (C) 452, consisting of neurons, connected by axons, synapses, and dendrites, all connected in a neural network is represented by a compact genome, which is a small structure of data consisting of numbers and alphanumeric data, which compactly represents the topology of the network, the number and size of layers, the types of neurons in them, and the statistical distribution of the connections from neurons in one layer or topological region to another. These genomes (G) 458 always expand deterministically to the same connectome C 452, and they interpolate smoothly, such that a genome G 459, that is interpolated to be between G0 457 (expands to C0 451) and G1 459 (expands to C1 453), when expanded, will result in a neural net connectome, C 452 that is between C0 451 and C1 453 in properties. This ‘smoothness’ property is necessary for the genetic algorithms to converge.

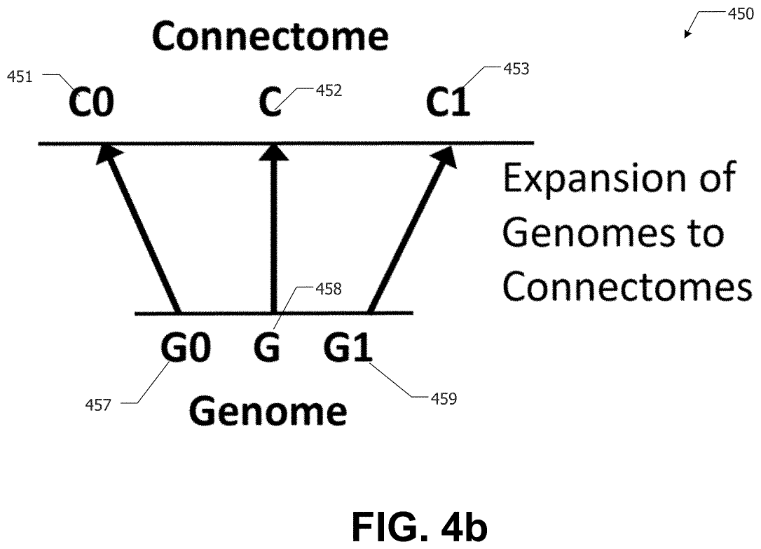

FIG. 5 illustrates an autoencoding process 500 for providing artificial intelligence using neural networks and other computer hardware and software devices and methods to simulate human intelligence according to the present technology. The present technology puts the data 501 through an SNN autoencoder 502 and in the mid-section 503 a volume where the data is processed through a bottleneck intentionally to reduce the representation to the smallest possible format that can still be reconstituted to the original data. This constriction or narrowing during the autoencoding process 500 and enlarge it again in a decoder 504 to create reconstructed version of the data 505. Comparison of the input data 501 and the reconstructed data 505 trains the autoencoder 502 to reproduce the original data; by doing so, the input data 501 is compressed at the constriction 503 in a way that the entire autoencoder circuitry stores all the common features of the entire data set it has encoded to date. This compressed representation of the data generated by the autoencoder 501 is a set of basis vectors, and the output at the constriction is the set of basis coordinates referencing the basis vectors internal to the autoencoder 501. The present technology takes the output from the area or volume of constriction for each input and records this into memory in time as an ‘Engram stream’ or encoded memory stream that is analogous to human short-term memory in the hippocampus.

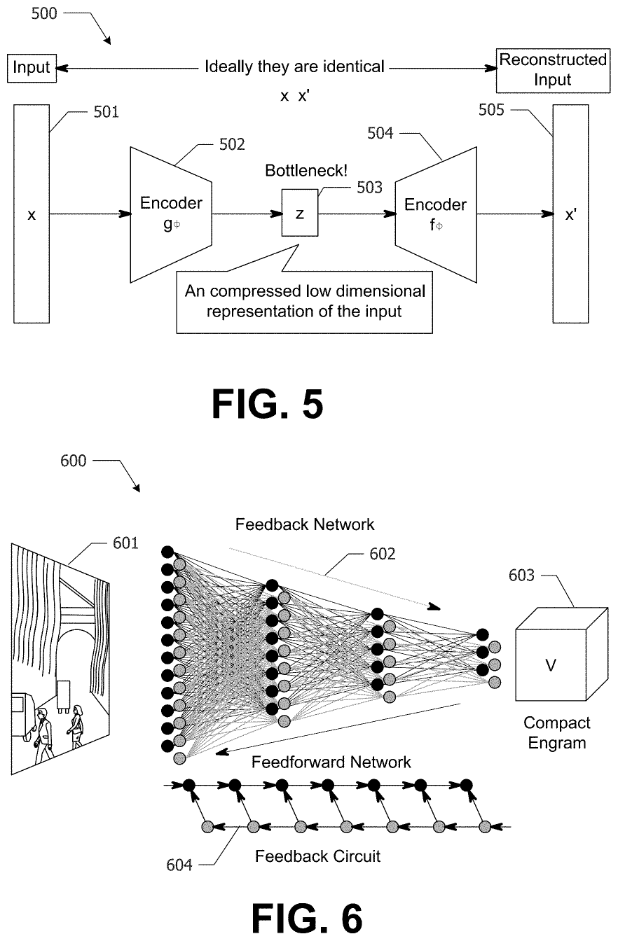

FIG. 6 illustrates an autoencoding process 600 of video data for providing artificial intelligence using neural networks and other computer hardware and software devices and methods to simulate human intelligence according to the present technology. One example would be to auto-encode video 601, where a series of grayscale images are sent to the input of the autoencoder, mapped onto to the top layer of neurons of the autoencoder 602, then the SNN passes it down through the even, encoding layers and into the compressed, low-dimensional representation 603. It is then decoded 604, and passed back to odd decoding layers, with the decoded representation on the 2^{nd} from top layer of our SNN. The compressed, low-dimensional representation 603, and the encoding 601 and decoding 604 processes are learned at runtime during training of the neural network, and typically cannot be interpreted by humans except by decoding them with the same SNN autoencoder.

What is novel in the present technology is the use of evolutionary methods to evolve SNNs specialized for different functions, including bidirectional interleaved autoencoders 602-603 that consist of layers of neurons that alternate between ‘even’ layers containing mostly forward connections, skipping one layer to the ‘odd’ layers containing mostly reverse connections, with those connections skipping a layer to the next odd layer, with some crossover in the connectivity, with final connectivity determined by genetic algorithms and training. Input data 601 comes in at layer 0, is encoded through the encoder into the bottom layer(s), where it is forced into a constrained bottleneck, and then decoded back through the autoencoder to layer 1, which is fed back into the even layers to generate a training feedback loop. The exact connections between layers, and feedback is determined by evolution via the genetic algorithms to find the configuration with optimal performance, with the selection criteria including encode/decode quality, latency, and encoded size) with the encoding and decoding method and encoded format learned at runtime in training and evolution.

The present technology auto encodes these input streams each time step, then takes the volume from the compressed, low-dimensional input of the autoencoder and copies it into an Engram stream, stored as a series of volumes in time. For example, a vision input from a video camera would be input to the top layer of neurons in the autoencoder. The pixels in a grayscale image are sampled by each neuron, such that any resolution of image can be used, and those samples averaged to create a current that is input into the neuron.

In SNNs, the current, or spike frequency, defines the value of a variable being communicated via that axon-synapse-dendrite connection, so the spiking neural network is essentially an analog computer, integrating and differentiating these signals. The SNN Autoencoder (an embodiment of an SNN analog computer) compresses and encodes the images arriving in sequence down into a 3D Engram volume, which combines both the spatial and temporal domains in the encoding, as information from past frames is still latent in the autoencoder, and this property is essential for later predictive computing. The encoded Engram is simultaneously being decoded back to the output, with the feedback between the feedforward and feedback networks training the autoencoder. For color images, encoded as 3 components in RGB or YCbCr format, there are three input layers that connect down into the autoencoder and are merged in the top few layers, so that Engrams are encoded as single components. Then, in a process where there can be one or more such inputs generating multiple Engram streams, inputs may be encoded into one Engram stream each, both into the same Engram stream with interleaving, convolution, addition or other operations, or a hybrid where they are encoded into their own Engram stream, and both encoded into a hybrid Engram stream with interleaving, convolution, addition, or other operations.

Encoded Engrams are extracted from the low-dimensional constricted volumes of the autoencoder at the time they are recorded, termed an Engram stream, representing a compressed record of the inputs in time, that can be reconstituted or decoded back into the original input. The present technology has a starting point with being able to reduce the sensory inputs for the AGI system 100 to this compressed Engram format, but they are still unwieldy, and cannot be used for useful operations on the data, except for volumetric convolutions to test them against other Engrams. The present technology has developed a better basis set for this purpose.

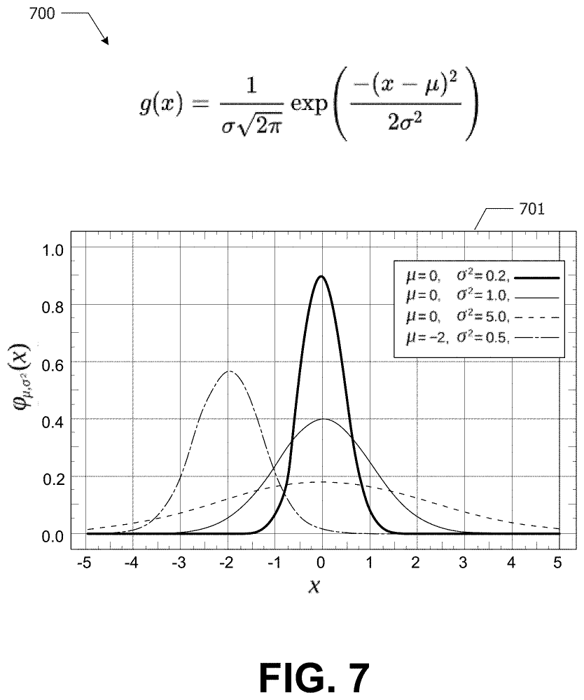

FIG. 7 illustrates using a Gaussian or other function with a localized span in time convolved with an engram stream to sample intervals or segments 700 of engram stream data for providing artificial intelligence using neural networks and other computer hardware and software devices and methods to simulate human intelligence according to the present technology. FIG. 7 shows sampled intervals or segments 700 of Engram stream data for providing artificial intelligence using neural networks and other computer hardware and software devices and methods to simulate human intelligence according to the present technology. An example process of data is to combine the input from stereo cameras by encoding two different camera inputs into the same Engram, with each camera input into a different area of the top layer and merging them in the lower layers of the autoencoder, before outputting one Engram for two input streams. The audio, in the form of a 1D-waveform, or spectrum waterfall in 2D, may optionally be input into the autoencoder and encoded within the same Engram as vision. However, processing of audio and speech is separate in the human brain, each in a different part of the cortex, otherwise the number of combinations of audio and video inputs would be massive, so the present technology choose to emulate this and process video and audio separately, but the auto encoding process is the same. FIG. 7 shows an example 1D waveform 701 using the above example.

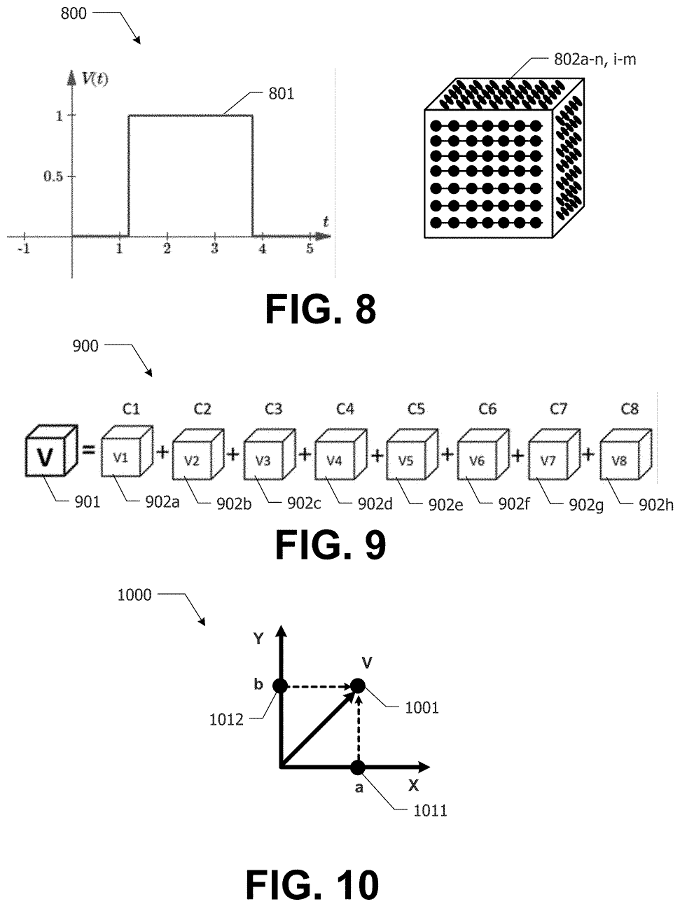

FIG. 8 illustrates using a step function or other function with a localized span in time convolved with an engram stream to sample intervals or segments 800 of engram stream data for providing artificial intelligence using neural networks and other computer hardware and software devices and methods to simulate human intelligence according to the present technology. FIG. 8 shows sampled intervals or segments 800 of Engram stream data for providing artificial intelligence using neural networks and other computer hardware and software devices and methods to simulate human intelligence according to the present technology. By point-sampling the Engram stream in time at the discrete frames, or by convolving the Engram stream with a function (such as a unit pulse function or Gaussian) spanning multiple Engram frames, the present technology can create sampled intervals or segments, at different time intervals (t+j*dt). By choosing the convolution (by the designer of the AGI and/or a combination of genetic algorithms) function parameters, and the value of dt, this will determine the overlap in time of the volumes. With a unit pulse function 801, the width and overlap are the parameters set, and with a Gaussian, the present technology sets a soft overlap with the setting of upsilon and sigma. By doing this, the present technology reduces the Engram stream to a set of 4D (x, y, z, t) unit volumes in four dimensions 802a-m i-m, with a little ‘swirl’ of reality in time in each volume. This is analogous to how information is stored in the human brain, in 3D volumes with time-domain patterns.

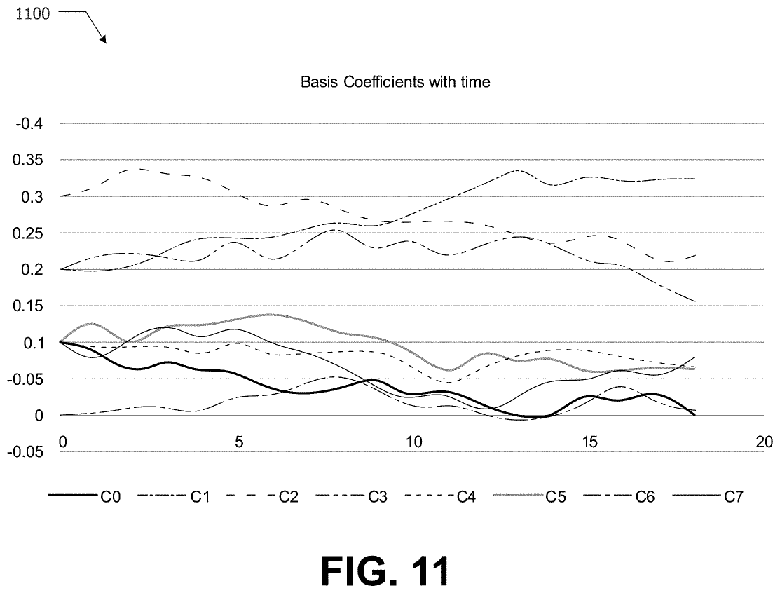

FIG. 9 illustrates an orthogonal basis set of such volumes of engram stream data for providing artificial intelligence using neural networks and other computer hardware and software devices and methods to simulate human intelligence according to the present technology. FIG. 9 shows an orthogonal basis set of such volumes of Engram stream data for providing artificial intelligence using neural networks and other computer hardware and software devices and methods to simulate human intelligence according to the present technology. These volumes 802a-n, i-m of data are a more compact and useful format than either the raw inputs or the longer Engram streams. The present technology can create an orthogonal basis set of such volumes 902, essentially a set of orthogonal basis vectors 902a-h that spans the space of previously experienced Engram segments 901, then any Engram segment can be decomposed into a linear combination of the vectors of this basis set by convolution with each vector of the basis set in a reversible process. When the basis vectors are each multiplied by the corresponding basis coordinates and they are linearly combined, the original Engram segment is reconstituted.

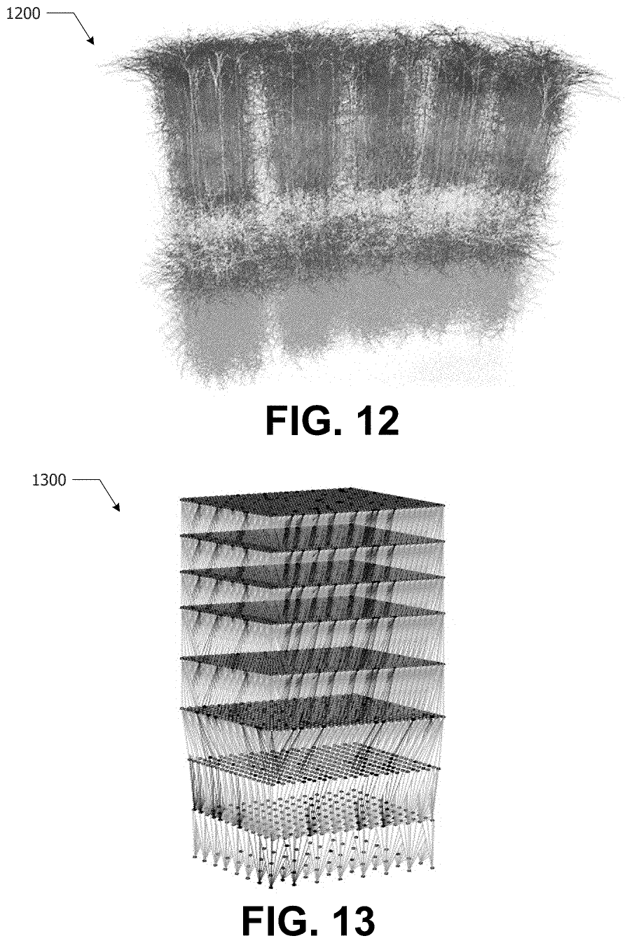

FIG. 10 illustrates an example of a basis vectors and coordinates for providing artificial intelligence using neural networks and other computer hardware and software devices and methods to simulate human intelligence according to the present technology. An example of a basis vectors 1001 and coordinates 1011-1012 are a simple 2D x-y graph, where X 1011 and Y 1012 represent basis vectors that are orthogonal to each other, and a and b represent the basis coordinates. When these basis coordinates are multiplied by the basis vectors 1001, the basis vectors can create any vector V, in the 2D space, and the basis vectors are said to span the entire 2D space.

Another example is that Engram basis vectors for written language would be the set of letters and alphanumeric symbols, and for verbal speech, the set of phonemes and duoemes. Each time an Engram segment (auto-encoded from image for text or from a waveform for speech) can then be convoluted with these basis vectors to compute the basis coefficient for each basis vector(s).

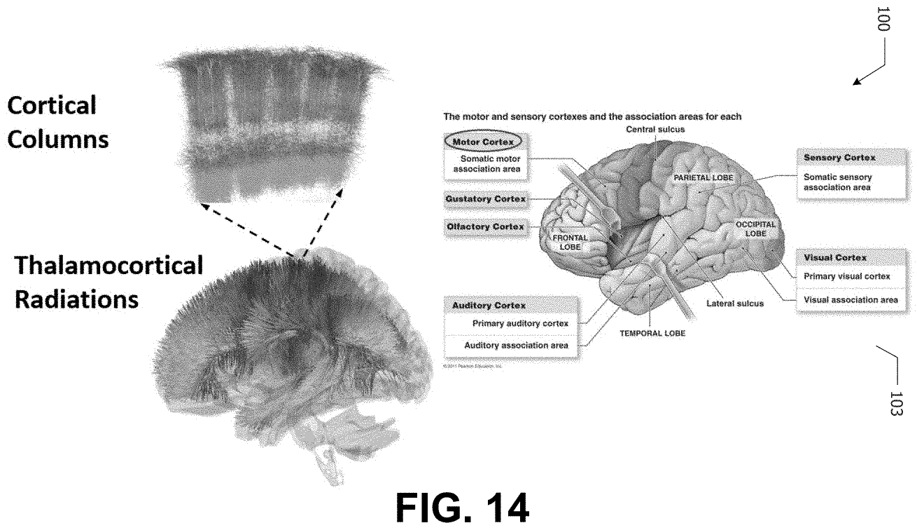

Similarly, the 4D Engrams for visual input can be convolved with the set of 4D spatial-temporal basis vectors for vision to get basis coefficients that correspond to specific visual features or objects. Later the present technology adds an ability for temporal analysis to characterize actions and events. By assembling the computed basis coordinates in a sequence as each sequential Engram is encoded, we create a time-series of basis coordinates (TSBC) as per FIG. 11.

FIG. 11 illustrates an example of the time-series set of basis coordinates for providing artificial intelligence using neural networks and other computer hardware and software devices and methods to simulate human intelligence according to the present technology. The present technology may create the time-series set of basis coordinates (TSBCs) or a ‘narrative’ in long-term memory. The TSBCs are essentially a stream of numbers 1101 that are much more useful for doing calculations than either the raw input or Engrams would be.

The orthogonal basis set of the present technology must be computed. Usual methods like Gram-Schmidt would be too costly, because for our system, the present technology needs a basis set of 4D engrams that can potentially span all of visible or audio reality for vision or speech. The size of the basis set, and the mechanism for computing it would be immense and computationally prohibitive with these methods, so the processing within the present technology needs to be able to work in parallel.

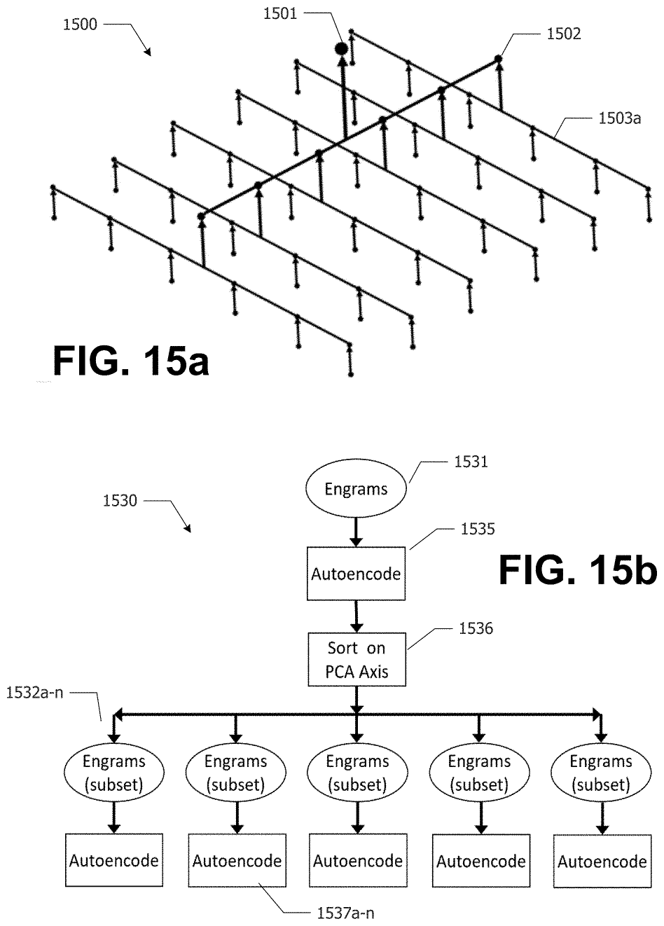

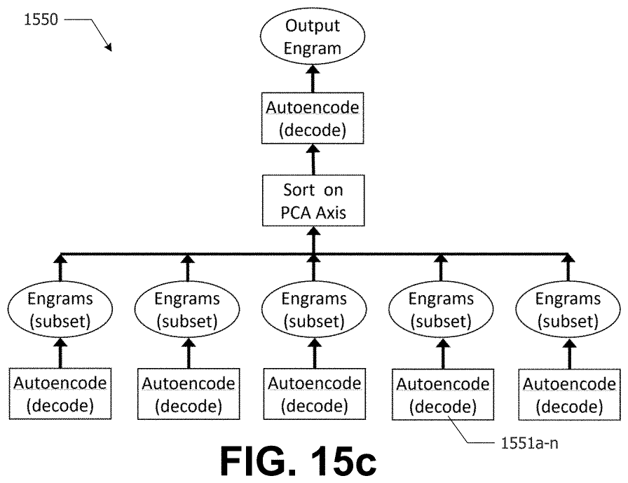

Fortunately, the present technology utilizes an analogy of such a system in the human brain. The human brain has analogous structures shown in FIGS. 12-14. The cerebral cortex is a sheet about 4 mm thick wrapped and folded around the outside of the brain, that consists of cortical micro columns 1200, each containing about 100,000 neurons, 7 neuron-layers deep. The cortical columns and an artificial analogy 1300 may be generated by the present technology's SNN autoencoder as shown in FIG. 13. These cortical columns 1200 look a lot like our autoencoders, which take in inputs like vision and audio and encode them into a compact Engram 1300, storing the common information about all the inputs it has seen in the autoencoder circuitry and the unique information about each input in the Engram.

In general, the present technology utilizes a method of decomposing Engram segments into a set of basis vectors spanning all previous Engram segments by passing them down a branching hierarchy that subdivides them by features till the leaf nodes of the hierarchy are each unique, sharing no common features, and thus form an orthogonal basis set of Engram vectors.

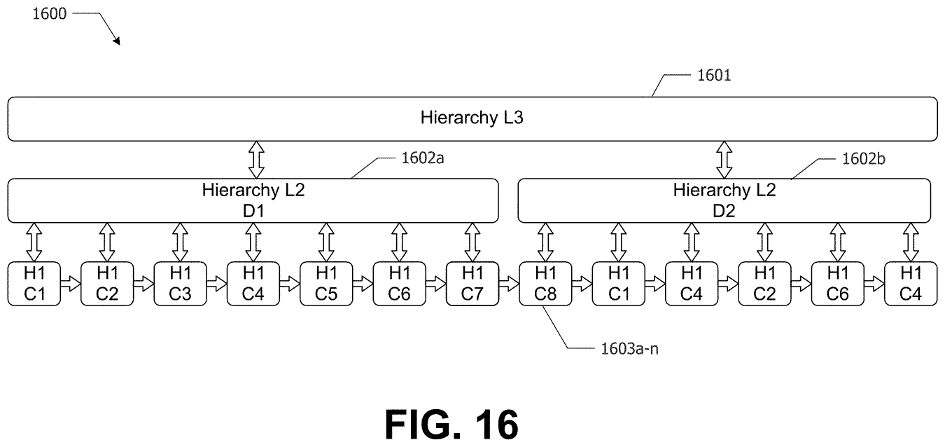

There is a biological analogy for this hierarchy as shown in FIG. 14: the thalamocortical radiations 1401, a neural structure that branches out like a bush from the thalamus (the main input/output hub of the brain for the senses, vision, audio, and motor outputs) with the finest branches terminating at the cerebral cortex, feeding input from the senses to each of the cortical columns. The cortical columns of the cerebral cortex are analogous to our terminal layer of autoencoders 1300, whose purpose is to store the orthogonal basis vectors for reality and do computations against them, including computing basis coordinates from input Engrams. Each section of the cortex is specialized for a specific type of input, such as visual, auditory, olfactory, etc., or output, including motor and speech, and the present technology has a separate hierarchy and autoencoder basis set for each mode of input, to generate basis coordinates for that input/output mode.

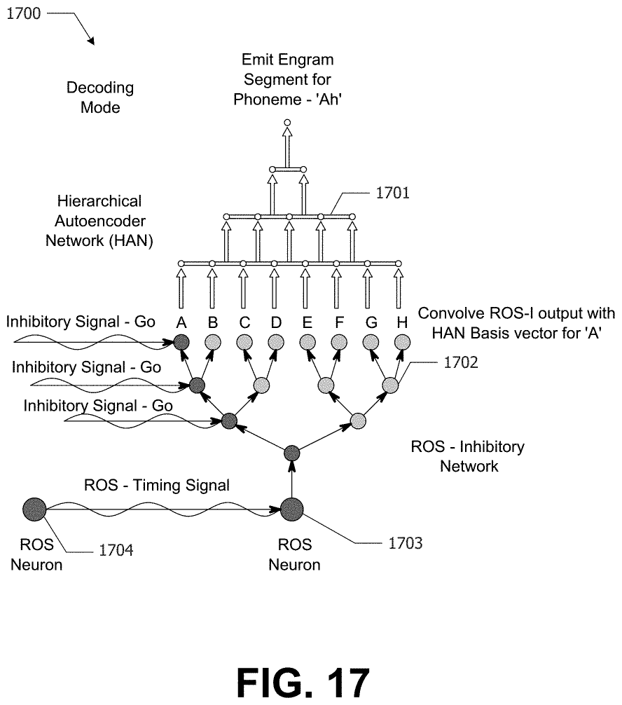

FIG. 15a illustrates an example of an orthogonal basis set of Engram vectors for providing artificial intelligence using neural networks and other computer hardware and software devices and methods to simulate human intelligence according to the present technology. FIG. 15b illustrates a flowchart of the generation of an orthogonal basis set. More specifically, the present technology utilizes a method 1530 for dynamically creating an orthogonal basis set of Engram vectors 1501, by submitting a batch of Engram segments 1531 that are processed by an autoencoder 1535 and sorting them each along an axis by a PCA technique 1536, with the Engrams sorted by a specific feature 1502, with this feature either explicit or learned by the adaptive PCH method for each axis, forming clusters of Engrams along the axis. These clusters are then each encoded by a specific autoencoder 1537a-n, removing their common feature, and then the resulting Engrams are spread out on new axes 1503a-n sorted by new features, determined by an explicit or implicit method.

With each level going down the hierarchy, more compact Engrams are auto encoded, with the feature differentiating it from the other Engrams on its PCH axis 1502 removed. This process is done recursively until one, much smaller Engram remains in each cluster, giving us a set of leaf nodes that constitute an orthogonal basis set of vectors 1500. New Engram batches can be added later to create new clusters, autoencoders, axes, and basis vectors, making it dynamic and able to learn. The present technology refers to this structure as a hierarchical autoencoder network (HAN network).

For example, to determine the most common feature to sort along an axis, the present technology performs a mathematical operation on all the Engrams to be sorted via PCH on that axis to determine in what way they most differ, or what is their most distinguishing feature. Methods to accomplish this could be:

Find an averaged Engram, then subtract it from all the other Engrams to see which features stand out the most.

Split the Engram into a 3×3×3×3 set of cubes, then compute the distribution of the voxel values along each axis and rotation around each axis as sorting criteria, as it goes down the HAN network.

Other predefined mathematical and logical operations at each level of the hierarchy.

Implicit methods, learned by the PCH algorithm itself being SNN based and evolved and trained to do optimal sorting at each level and each axis.

To determine the basis coefficients for a single input Engram segment, the Engram segment is passed through the process specified above, but singularly, splitting it off into Engram segments that each traverse the correct portion of the hierarchy, as determined by the same criteria as disclosed above for the batch Engrams, until convolution with the basis vectors at the leaf nodes determines the basis coefficients for that Engram. This process can be used in reverse, multiplying the basis coefficients with the basis vectors at the leaves and passing them back up through the HAN network to reconstruct the original Engram. This method provides a system that can deconstruct reality to numerical basis coordinate vectors, which are easier to operate on, and back. Basis coordinates are stored with an index to the Engram basis vector that they are associated with, as most inputs will produce a sparse set of basis coordinates with most being zero.

FIG. 15c illustrates a sequence that decodes from basis set engrams back to real-world outputs, where the prior diagram describes the encoding.

These singular Engram segments are also each stored in order, in short-term memory in the Engram stream that is being buffered for the next time the AGI does the batch Engram process disclosed above. This method can parse incoming inputs during operation or ‘waking,’ and also buffer the data and use it to further build the HAN network when in batch, or ‘sleeping’ mode. This is probably why all life on earth sleeps; because consolidation and organization of memory requires a different process than brains use while waking.

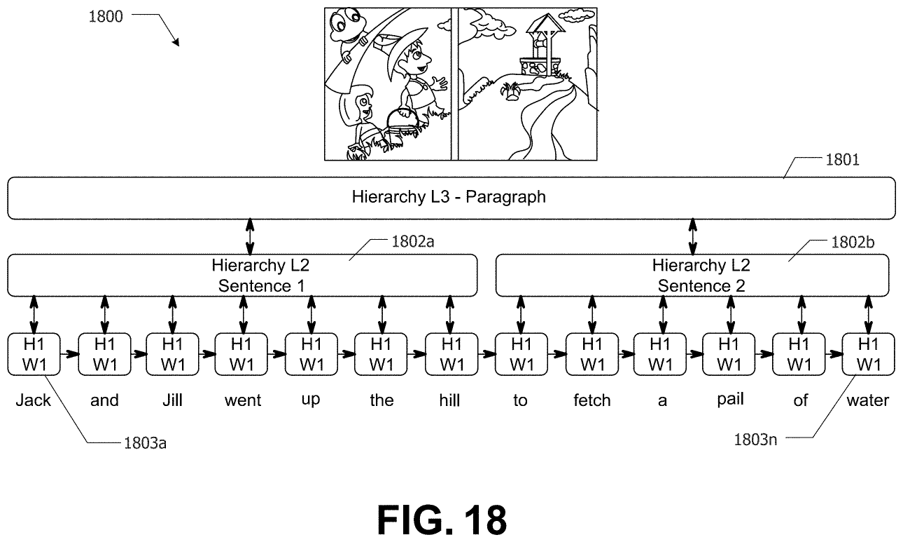

FIG. 16 illustrates an example HAN network for providing artificial intelligence using neural networks and other computer hardware and software devices and methods to simulate human intelligence according to the present technology. The HAN network is a general purpose algorithm using generic Engrams that have the same format and function regardless of what type of input or output data they represent or process. Although through training and evolution, the audio, speech, visual, and other HAN networks may diverge in their parameters to function optimally, the underlying data structures and methods of the HAN networks are general. This is where the design of the present technology becomes Artificial General Intelligence, where everything input can, from now on, be processed, transformed, and operated on by general purpose methods.

The present technology compresses inputs into Engram streams, segmenting them, and dynamically building a basis set from them, then using that basis set to transform Inputs into Engrams into basis coordinates. Another problem arises in that these basis coordinates could be massive vectors of numbers. The human brain contains 1 million cortical columns (spread across all the senses and functions). If ¼ of the cortical columns/Engram basis vectors are for vision, that gives us a basis coordinate with 250,000 elements, which is going to be difficult and computationally expensive to do operations on, especially when they consist of a time-series narrative with 24 basis coordinates per second (human vision perception rate). In addition to compressing the TSBCs to be indexed when they are sparse, the present technology needs a way to compress and manipulate this time-series data for temporal operations (including speech) and recognizing events and actions in visual data and encoding trends in general data.

The present technology uses a method for organizing a time-series of data such that it is arranged hierarchically and/or connected to other segments and/or hierarchies to form composite structures 1600 in memory. Any TSBCs segments 1601-1603 that are often repeated can be collapsed into a more compact representation, and instanced, with multiple points in multiple hierarchies referring to the same instance of the segment (or hierarchy structure). These repeated child segments or hierarchies 1602a-b need only be stored once in memory, forming ‘macro’ basis sets whose properties and connectivity to other data only need to be computed once, reducing space and computational requirements. Where high level ‘macro’ representations are available, the lower level, high frequency data can be omitted, unless there are small changes, then specific lower-level representations at specific points in time can be added, subtracted, or substituted for portions of the high-level representation, making the system very flexible, powerful, and able to rapidly build on existing knowledge and learn more quickly as it goes. These data structures are referred to as Hierarchical Times Series Inhibitory Signals or HTSIS.

An analogy is a music box with a set of pins placed on a revolving cylinder or disc to pluck the tuned teeth (or lamellae) of a steel comb. In the example of an adjustable music box, the present technology can place each pin individually or place a set of pins representing a sequence of notes that repeats often in the musical sequence. This pre-configured set of pins reduces the data needed to describe the music sequence and makes it easier to compose music on it. In this example, the present technology can reduce a series of data that is often repeated to a hierarchically organized set of macros, or pre-defined sequences of that data, 1600 and not have to explicitly represent each data point.

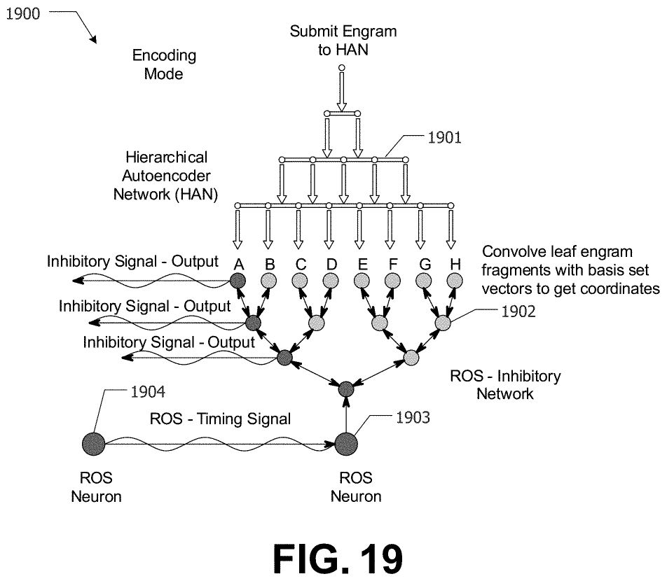

FIG. 17 illustrates an example translating time-series basis coordinates for providing artificial intelligence using neural networks and other computer hardware and software devices and methods to simulate human intelligence according to the present technology. The present technology defines a method for translating time-series basis coordinates (TSBCs) into a more compact and useful format of inhibitory signals structured hierarchically 1700 by using an artificial ROS-Inhibitory (ROS-I) neural network 1701. In the brain, a ROS-I network hierarchically creates a sequential output, starting with a series of linear neurons that fire sequentially, called Rank Order Sequential or ROS neurons that, by firing in a sequential chain, set a tempo or pattern with time (t), for a sequence of outputs, where that time-series ROS signal along this linear chain is the same regardless of the output to generate. This signal at each ROS neuron 1703 is then input to the root of each of a plurality of hierarchies of branching structures of neurons, terminating in neurons that connect to the leaf nodes in our HAN, delivering the basis coordinate for that basis vector, in a similar way to how the human ROS-I system connects to the cerebral cortex, which also connects to the thalamocortical radiations.

In an artificial ROS-I network 1700, a linear series of artificial neurons 1703-1704 fires in sequence, generating an excitatory signal when each one fires, causing each root artificial neuron in the attached branch structures to fire, and as the signal cascades down the inhibitory neural network, it is selectively inhibited by an external, time domain control signal at each neuron, by modulating the neuron's outgoing signal by its inhibitory signal. Overall, this selects which branches of the hierarchy are activated by controlling the inhibition at each neuron in that hierarchy.

Each branching hierarchy forms a spatial-temporal basis set that can be controlled by the inhibitory signals 1704a-c at each level in that hierarchy (like our pin groups in the music box example), and the outputs from each can be blended, added, subtracted, and substituted with those further down the hierarchy and in parallel hierarchies via these inhibitory signals to form novel output units that are sequenced temporally. This network 1700 is trained by back-driving the desired outputs to train the inhibitory signals (via simple regression) such that later they can be generated from time-series basis coordinates, creating a much more compact hierarchical structure for the data that enables learning that accelerates with time.

The present technology also may perform the reverse process with this system, by inputting the trained HTSIS into the ROS-I network to create the output in the form of TSBCs, which can be processed or input into the HAN for transformation to a real world output.

Using the above processing, the present technology system is analogous to the human brain, where the passage of input from the senses (audio, vision) goes to the thalamus, out the branches of the thalamocortical radiations, to the cortical columns, being transformed by a basis-set mapping, out through the ROS-I network doing a temporal basis set mapping to more compact time-domain signals. In this analogous system, the input data is compressed to an Engram, which is split into its component features by the HAN network, then at each leaf node of the HAN network, each Engram component is transformed by the Engram basis vector at that leaf node, into the time-series basis coordinate (TSBC) emitted into the terminal neurons of the ROS-I network to back-drive signals into it and train hierarchical time-series inhibitory signals (HTSIS) which are a much more compact and useful form of information to use in sequential processes like language (speech, text), and actuator control, where very complex sequential output is generated from small signals.

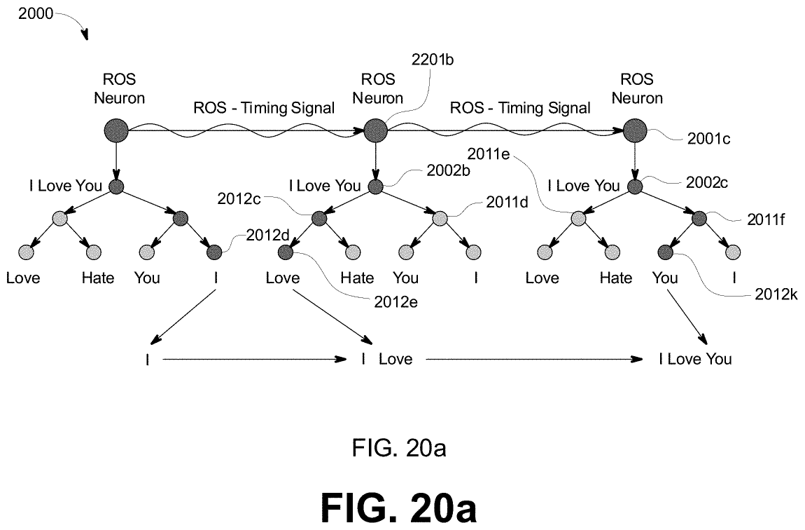

FIG. 18 illustrates an example organization of language time-series narratives for providing artificial intelligence using neural networks and other computer hardware and software devices and methods to simulate human intelligence according to the present technology. The present technology proposes a method for organizing language time-series narratives structurally as shown in FIG. 18 for human language, such that each character for written language forms a basis vector, instanced in the language time-series narrative by a basis coordinate. Spaces delineate segments consisting of words, punctuation delineates a segment (a hierarchy spanning words) of sentences 1802a-b, and CR characters 1803a-n delineate a segment (hierarchy of sentences) defining paragraphs 1801. Similar organization is done for spoken language by having phonemes as the basis vectors, referred to by a basis coordinate, pauses delineating words, and longer pauses delineating sentences and paragraphs. Symbolic languages will be similarly structured in narratives and organized into hierarchy according to their written and spoken structure.

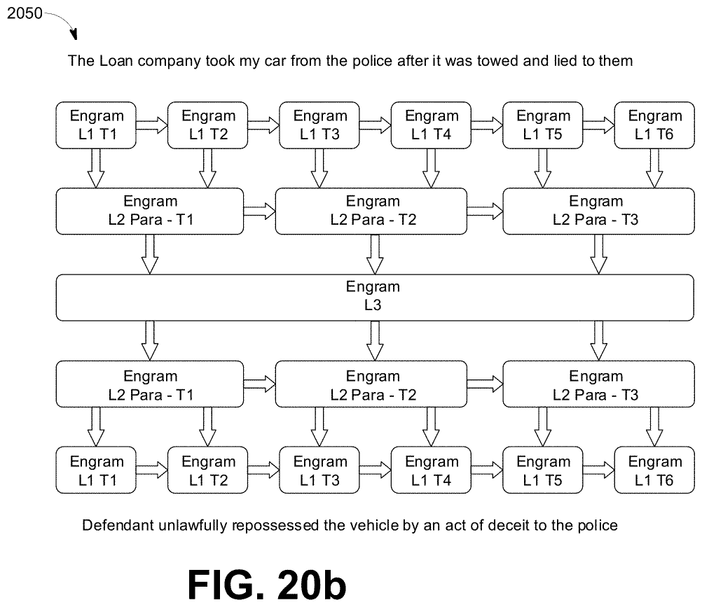

FIG. 19 illustrates an example of a HAN encoding network for providing artificial intelligence using neural networks and other computer hardware and software devices and methods to simulate human intelligence according to the present technology. In a speech example, the present technology inputs an audio waveform as a 1D-waveform or a 2D-spectrum waterfall into the AI Input via the input autoencoder. This data would then be compressed and encoded into an Engram, then passed down the HAN network 1900 to be convolved with a set of basis Engram phonemes and duoemes to produce a stream of TSBCs. Then those TSBCs would be input into the terminal nodes of the ROS-I network to back-drive the system and produce a HTSIS for the speech as output.

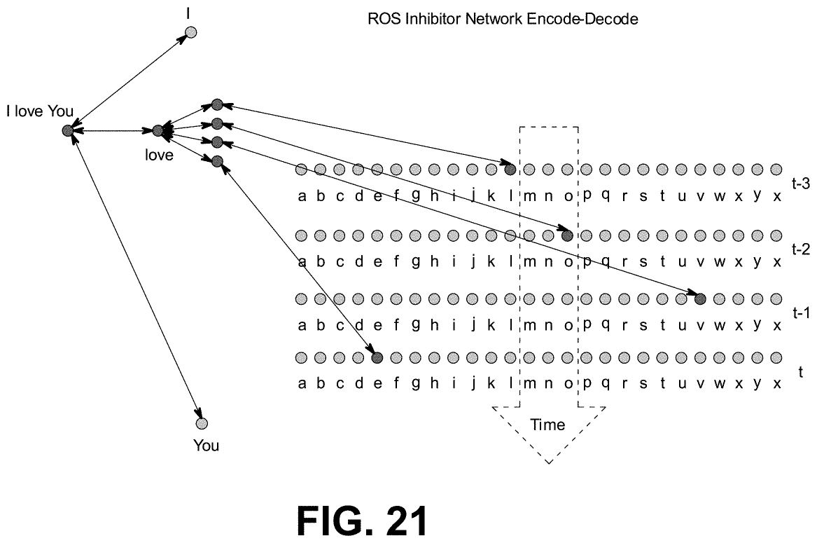

FIGS. 20a-b illustrate a speech-based example use of a HAN encoding network for providing artificial intelligence using neural networks and other computer hardware and software devices and methods to simulate human intelligence according to the present technology. By repeatedly training this system on a set of speech/language inputs, with the input to the terminal branches of the ROS-I network reaching and only training the lower levels first, it would first learn a sequence of phonemes, then progressively whole words, phrases, sentences, and larger groupings, like a chorus in a song, or repeated paragraphs in legal documents.

The English language has 26 letters, plus 26 capitalized, plus numbers and punctuation, but has 470,000 words. The HAN network has already learned to map the text images and phonemes to letters. The ROS-I learns the letters by allocating a new neuron at the lowest layer each time a novel input comes in from the HAN network and connects it to that neuron with a certain weight at the synapse (say 0.2). Each time a signal comes in from the HAN network for that letter, the weight at the synapse is increased by 0.1, strengthening that synapse. By this process, the ROS-I network lower layer can learn any alphabet or symbolic language. Each time the character receives a signal, it increments the channel for the character at the lowest level of the HSTIS for that time interval by the value of the character in that word and increments it by 0.1.

FIG. 20a shows a specific speech-based example use of a HAN encoding network. The ROS-I network holds the characters in a buffer until it detects a space or punctuation character, then it ‘searches’ the second level of the hierarchy 2002a-c for a neuron for the word formed by the letters in the buffer. It does this by firing the letters of the word in a sequence, to see if any words exist with that sequence, and each time the word receives a signal it increments the channel for the word at the 2nd level of the HSTIS for that time interval by 0.1, otherwise, if it does not find that word, it allocates a neuron for the word, plus a ‘trigger’ neuron for each letter, with the appropriate delay in the sequence to put the character in the right place in the word. Then it makes a connection from each of the letters to their trigger and vice versa, initializing the synapse of that connection with a value (say 0.2). This process continues up the hierarchy with sentences, then paragraphs as far as the neural net can store and compute.

This is the way humans learn speech as babies, sounding out syllables and babbling, then learning to speak words one syllable at a time, then smoothly as whole words, then whole phrases, sentences, and paragraphs. Because new temporal basis sets are being laid down by this process at each step, learning accelerates as it builds on them in both humans and in our artificial methods.

Once trained, the present technology may be run forward, with the ROS-I /excitatory neurons firing in sequence, and playback of the trained HTSIS inhibitory signals modulating the activity of the neurons in the network to create a sequence of phonemes, words, phrases and paragraphs. This result is accomplished by setting each inhibitory neuron with the correct value (1 or 0) according to the signal at the same level in the hierarchy for that neuron 2001a-c. Then, when a signal is passed down the branch from the ROS-I network to the inhibitor network 2000, and if the value of a given neuron is not zero, the incoming signal from a neuron 2001a-c above is added to the value at the present neuron 2002a-c, modulated by the inhibitory signal of this neuron and passed down. If there is another letter in a word, or word in a sentence uninhibited below the level of the higher-level representation, it is given priority. In this way, the present technology can substitute a letter in a word, or word in a sentence, but still use the abbreviation of the higher level representations for common phrasing.

FIG. 20b shows the result 2050 of these operations for an example input. The above methods for speech would also work for controlling motion for robots and animated 3D-characters, with vision, proprioception, touch, and speech as inputs, and actuator commands or animation generated as a result, using networks of predictors and solvers to plan movement and execute high level commands from speech, either from an external source, or from its own internal monologue, using language as a code to specify movement. That speech can be organized hierarchically so there are low level movements like “flex pinkie finger right hand 10%” or high level commands like “walk forward 2 meters, turn left, and do the hokie pokie.” Internal monologues need not be just scripted, as they could be generated like our above conversation, reacting to what is happening in the world and what is predicted to happen next, then synthesizing intelligent movement based on training and practice. This is how humans learn to hit a tennis ball, or catch a baseball, by predicting where the ball will be, and initiating motor control commands before it gets to us, adjusting the whole way.

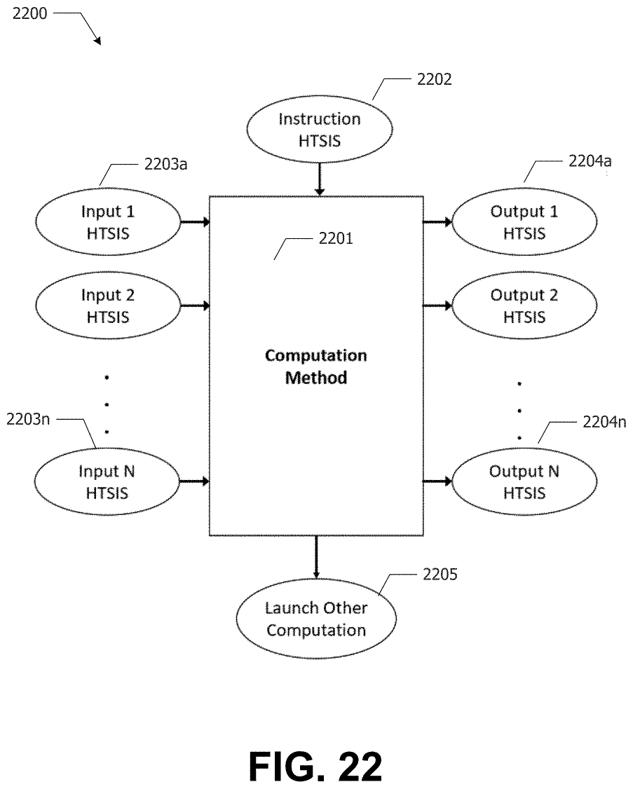

FIG. 21 illustrates a usage of a system for providing artificial intelligence using neural networks and other computer hardware and software devices and methods to simulate human intelligence according to the present technology. A method of training a human ‘mimic’ AI using the above disclosed methods by using data from a performance capture of a real person acting out a plurality of scenarios to supply the inputs and outputs to train the AI for the speech, vision, body movement, and facial movement of an artificial AI person, where that AI person can be without physical form, instantiated with 3D-computer graphics as a character, or instantiated as a realistic humanoid robot, with the motion and facial expressions mapped to the actuators for the latter, with the goal being to provide an AI with realistic, human-like dialog, lip-sync, facial expressions and functional movement. The detailed performance capture data can be augmented with simpler text conversations that may be general or specific purpose to a vocation, and other general data to fill in the blanks in training, and also augmented with dreaming between training sessions.

A method of simulating human intelligence and abstract reasoning by use of artificial intelligence in the present technology consists of connecting HTSIS data structures (disclosed in FIG. 16) that are derived from different input types, such as visual and language, at coordinates where they are temporally, spatially, or conceptually related, such that processing of one type of narrative can reference the related information in the other type of narrative as input or output in the processing. The method would connect between the higher levels of the hierarchies (34) to allow more abstract operations between the different levels. By further making language the backbone for our AGI's memory and cognition by connecting words to references of visual objects and sounds, sentences to form abstractions for scenes, sequences of visual and audio events, and paragraphs to form abstractions scenarios and stories in memory, with each word, sentence and paragraph connected to one or more memory.

By connecting the different modalities and anchoring vision, audio, and other data to language, the present technology not only gain a very robust system for recognizing objects, scenes, locations, actions, events in time, and identifying them with words and sentences, the present technology also have a conceptual abstraction at the higher levels of the hierarchy for how these concepts fit together and co-occur, so that the present technology can do operations on those abstractions that more closely resemble the human brain's ability to think and plan based on generalities, then dive into the details.

This allows the present technology to map more than one language to these concepts, objects, and actions, making a translator that is even more robust than the present day state of the art. The present technology can translate between dissimilar languages with very different structure and grammar much more effectively and easily. For example in this diagram is a translation from plain English to the legal language of civil tort law. This AI could translate a client's plain language document into a legal filing.

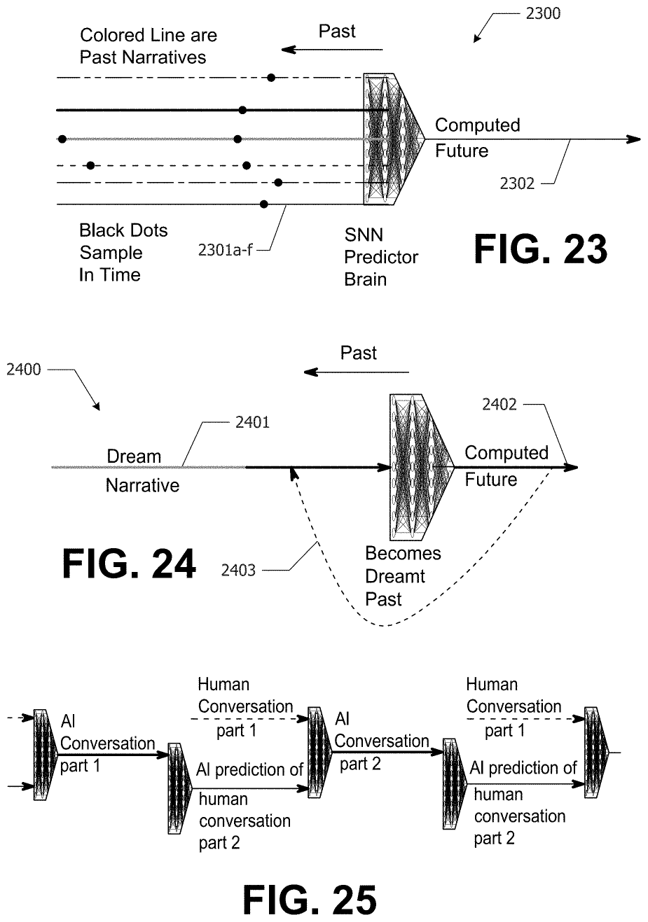

FIG. 22 adds a computational method for providing artificial intelligence using neural networks and other computer hardware and software devices and methods to simulate human intelligence according to the present technology by performing computations on the transformed mathematical representations of the inputs and outputs according to the present technology.

The present technology defines a method for doing computations on time-series data by sampling values from a plurality of data series, from a plurality of intervals in time, with components of these coordinates as input to a SNN, as defined above, which computes the set of values for points in time as output, optionally having input of instructions to perform operations with, and optionally the ability to launch other computations and do other operations. Before use, this SNN is trained on known inputs and outputs, and evolved to perform its operations optimally.

This method allows us to do arbitrary computing 2201 with a plurality of TSBCs as our inputs 2203a-n and outputs 2204a-n, and/or a plurality of HTSIS where the present technology additionally samples from all levels of the hierarchy for the inputs and write to all levels of the hierarchy as the outputs.

In a speech example, this computation method could be a translator, learning input in one language, and output in another language, training on already-translated documents encoded to HTSIS. Because the SNN is training not only on the sequence of letters, words, and sentences, but paragraphs, it will have better context and translational accuracy. This could translate written and spoken languages accurately, and also translate to and from everyday language to the languages of law or medicine with their own specific terms, words, and grammar. Again, being able to use the higher levels of the hierarchy like sentences and paragraphs where context, grammar and rules of composition are learned make this possible, where existing translators cannot do this because they only ‘see’ short sequences.

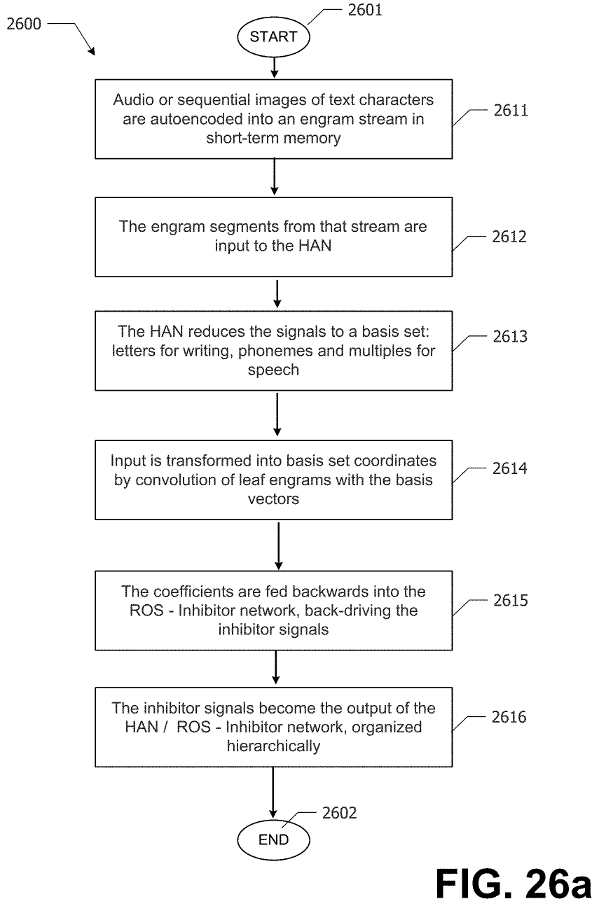

FIG. 23 illustrates a method for doing computations by sampling values from a plurality of intervals in time in past recorded data, with these the data input 2301a-f to a SNN, as disclosed above in reference to FIGS. 3-4 which computes the values of future data as output 2302. The present technology refers to this method as a “predictor” model 2300. Before use, this SNN predictor 2300 is trained and evolved on known inputs and outputs, and also evolves optimally to predict based on these data sets, either TSBCs or HTSIS.

In a speech example, this predictor 2300 would learn the sequence of letters, words, and sentences from a collection of written works. The present technology first encodes each work into a series of HTSISs built up from letters, words, phrases, sentences, and paragraphs. Then the predictor could train on these HTSISs and learn the sequence of letters to form words, words to form phrases and sentences, and even sentences to form paragraphs by training on hierarchical data all the way up to the paragraph level, the user supplies the beginning portion of a sentence to the predictor as an input, and it could output the next word, or even complete the sentence, having the whole hierarchy of words, sentences, and paragraphs as reference, making it very accurate.

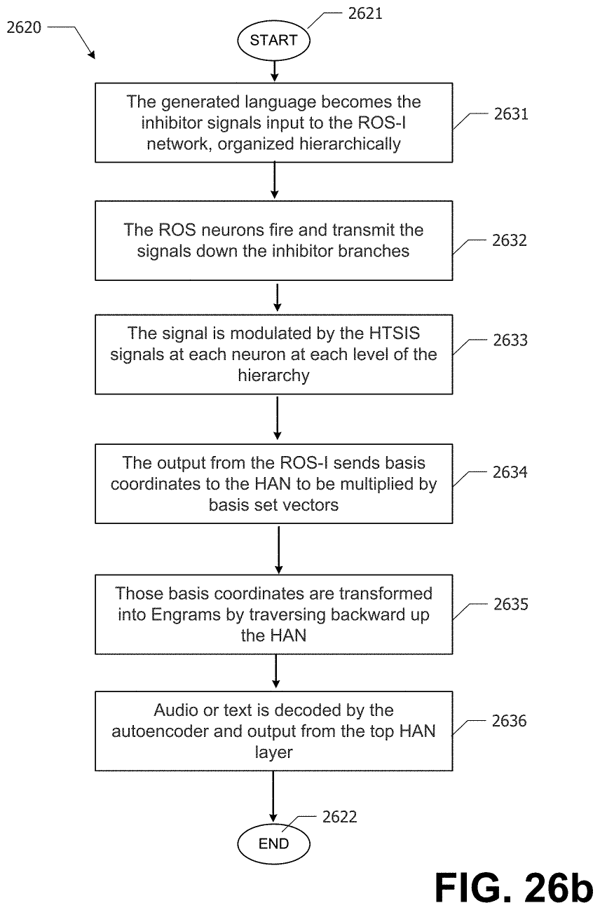

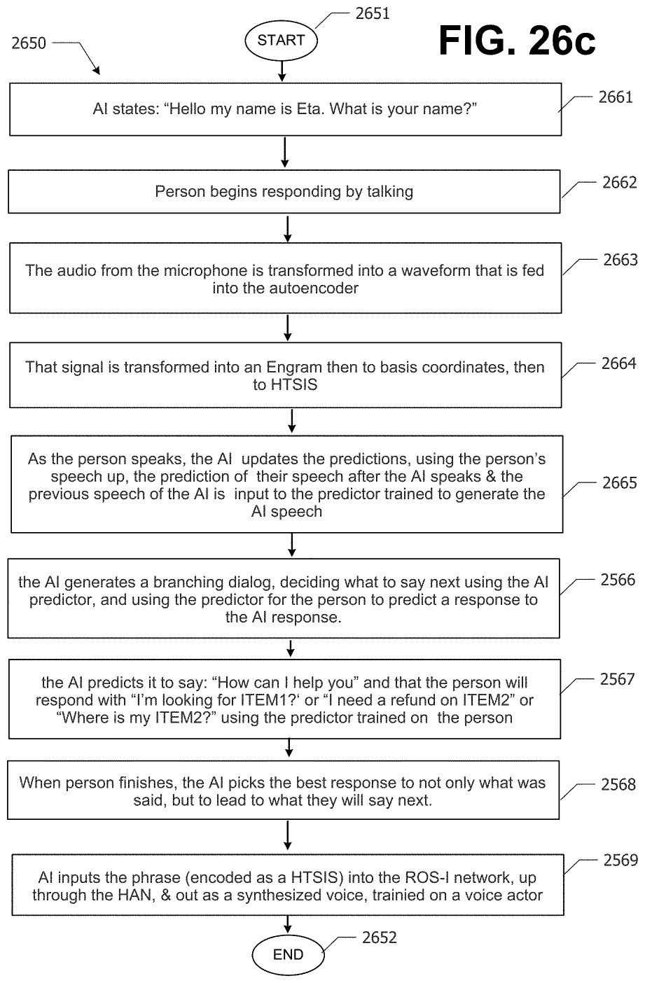

In FIG. 24 is a concept diagram of a predictor model, sampling past time-series, and the SNN neural network computing the future narrative. In FIG. 25 is a concept diagram of several such predictors combined in a method wherein the current present technology simulates one side of a 2-sided conversation, trained on a plurality of past conversations, then using information from the present conversation, simulating several responses to what the person is currently saying, and predicting how the person will respond to each in order to choose the best response to say.

FIG. 24 illustrates another example of a problem addressable by the AGI system 100 of the present technology is a method for synthesizing time-series data or ‘dreaming’ 2400 by allowing the predictor 2300 to start its prediction inputs on existing time-series data, then move forward in time, detaching from the narrative to compute its future predictions 2402 based on using input from its just-generated predicted time-series data, creating a fictional or dream narrative 2401 (shaped by its model of reality) in the memory narrative behind it in time. Optionally, it can ‘attach’ to an existing time-series data, by reading from that, then detach to dream, multiple times. This is repeated to create dream time-series that form a web connecting experienced time-series, to augment them. This method can be used on both TSBCs and HTSISs, with the hierarchical data giving much greater predictive power by supplying context and allowing training on more abstract concepts and long-term trends.

Additionally, a method of continuously evaluating the dreamed memories as they are laid down is yet another example usage. In this example, dreamed memories are encoded and then traversed later 2403, to decide if they should be attenuated or amplified, depending on their conformance to real memories and to the predictor model, and/or by reconstructing them into their corresponding Engrams, and/or output data format to be evaluated.

To enable an end to end encoding and decoding system for real world inputs and outputs The present technology has a branching pyramidal neural structure branching from each of the ROS terminal end neurons, through the branches extending from it, up to the HAN leaf node autoencoders such that each outermost branch originating at each ROS neuron terminates at one autoencoder, with the signal strength designating the basis coefficient fed into that autoencoder.

Now, when the ROS excitatory temporal input fires, the signal travels through the inhibitor network branches (modulated by the inhibitory signals to each branch), delivering basis coefficients that modulate with the basis vectors in the cortical column/autoencoder layer for that point in the sequence. These are then propagated up through the HAN network and decoded to a series of Engram segments corresponding to the output of the ROS-I network that are assembled into an Engram stream is decoded to the correct output by the autoencoder, be it audio, speech, visuals, actuator controls or other outputs.

FIG. 25 illustrates a method for the AI to converse naturally with a human, by training a set of dreaming predictors 2300 of FIG. 23 evolved, as disclosed above in FIGS. 3-4 to learn human language by training and evolution on a plurality of human conversations, where they both learn proper responses, grammar, and composition by each training to output one person's side of the conversation, on the hierarchy of words and sentences stated by each person in an alternating conversation using the method of FIG. 23. Then when actually conversing, the AI uses one predictor 2501 to make multiple predictions 2511 of what the other person will say next 2512, continuously updating those predictions 2521 and narrowing them as the human speaks 2512 and uses the other predictor to predict what the AI will say next 2522 in response to each of the human's predicted responses 2521. When the human stops speaking, the AI uses the best pre-computed speech segment to compute what the AI should say now 2523, pulling words and phrases from previous segments of the conversation to incorporate them using the ROS-I network substitution where appropriate, and dreaming where they need to ad-lib the conversation. Each predictor 2501-2504 would also have connections to the information about other modalities and their hierarchies shown in FIGS. 21a-c, including visuals, audio, date, time, and location to give the words context and to interface with peripherals.

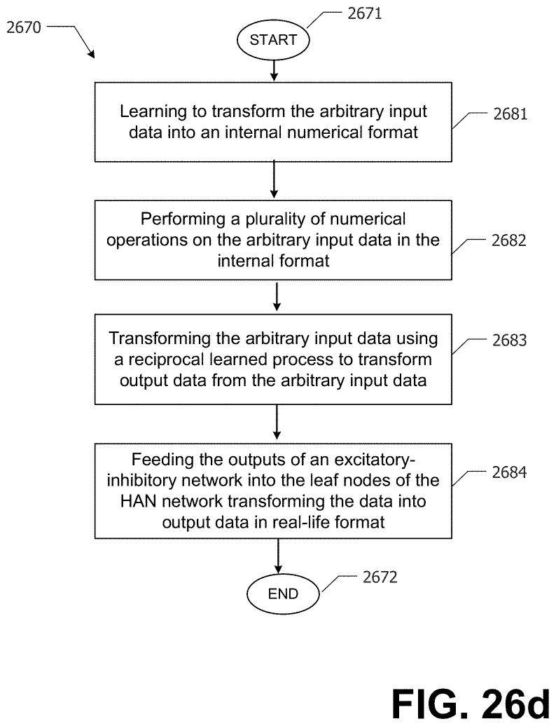

FIG. 26a illustrates a flowchart corresponding to a method performed by software components of a system for providing artificial intelligence using neural networks and other computer hardware and software devices and methods to simulate human intelligence to the present technology. A method 2600 combining such that the HAN network and the ROS-I network can learn to understand to write and speak human language just by reading or listening as follows:
a. Audio or sequential images of text characters are auto-encoded into an Engram stream in short-term memory in step 2611.
b. The Engram segments from that stream are input to the HAN network in step 2612.
c. The HAN network reduces the signals to a basis set: letters for writing, phonemes and multiples for speech in step 2613.
d. Input is transformed into basis set coordinates by convolution of leaf Engrams with the basis vectors in step 2614.
e. The coefficients are fed backward into the ROS-I network, back-driving the inhibitor signals in step 2615.
f. The inhibitor signals become the output of the HAN/ROS-I network, organized hierarchically in step 2616.

FIG. 26b illustrates a flowchart disclosing a method 2620 for taking the output of the language generation system and using it to generate spoken and/or written language, the method comprises:
a. The generated language becomes the inhibitor signals input to the ROS-I network, organized hierarchically in step 2621.
b. The ROS neurons fire and transmit the signals down the inhibitor branches in step 2622.
c. That signal is modulated by the HTSIS signals at each neuron at each level of the hierarchy in step 2623.
d. The output from the ROS-I sends basis coordinates to the HAN network to be multiplied by basis set vectors in step 2624.
e. Those basis coordinates are transformed into Engrams by traversing backward up the HAN network in step 2626.
f. Audio or text is decoded by the autoencoder and output from the top HAN layer in step 2626.

FIG. 26c illustrates a flowchart disclosing another example of usage of these systems for speech would be to make the system work in a simple greeter conversational system like that found in many customer service chatbots, but to deliver superior conversational capability. The method 2650:
a. AI states: “Hello my name is Eta. What is your name?” in step 2661.
b. Person begins responding by talking in step 2662.
c. The audio from the microphone is transformed into a waveform that is fed into the autoencoder in step 2663.
d. That signal is transformed into an Engram then to basis coordinates, then to HTSIS in step 2664.
e. As the person speaks, the AI continuously updates the predictions, using the person's speech up until that time, the prediction of what they will say after the AI speaks and the previous speech of the AI as the inputs to the predictor trained to generate the AI speech in step 2665.
f. Doing this, the AI generates a branching dialog, deciding what to say next using the AI predictor, and using the predictor for the person to predict how they will respond to the AI response. It looks ahead 2 moves essentially in step 2666.
g. In this example the AI predicts it should next say: “How can I help you” and that the person will respond with “I'm looking for ITEM1?’ or “I need a refund on ITEM2” or “Where is my ITEM2?” using the predictor trained on what the person will say in step 2667.
h. As the person finishes speaking, the AI now picks the best response to not only what the person just said, but that will lead into what they will say next. If the person said, “Hi AI, my name is Bob”, the AI will say something like “Nice to meet you Bob, are you looking for ITEM, or need to track or refund ITEM2?” in step 2668.
i. The AI inputs the phrase (encoded as a HTSIS) into the ROS-I network, up through the HAN network, and out as a synthesized voice, created by training on a voice actor previously in step 2669.

This process of speech recognition would be superior to existing speech recognition, natural language systems, and speech synthesis systems because the underlying AGI methods allow for the system to learn from just listening to a person speak, building a HAN network basis set of phonemes, duoemes and triemes from their voice that would make synthetic speech produced by it much more realistic, and make speech recognition much more robust, as it would be able to screen out any non-speech audio by using the basis sets convolutions, and be more able to handle slight mispronunciations and be able to train on people from different geographies to compensate for accents.

The ROS-I network makes a spoken voice much smoother because it does not just try to stitch together phonemes and their derivatives, it can learn to output whole words, phrases, and even sentences smoothly. As well, in reverse, it can still understand mispronounced words, poorly worded or grammatically incorrect phrasing or sentences, and draw inference from the context within the paragraph. It will perform better on the Turing test and perform speech recognition and synthesis at a level superior to a human, with fewer mistakes.

FIG. 26d illustrates a flowchart disclosing another example of usage of these systems for speech would be to make the system work in a simple greeter conversational system like that found in many customer service chatbots, but to deliver superior conversational capability. The method 2670:
a. learns to transform the arbitrary input data into an internal numerical format in step 2681;
b. performs a plurality of numerical operations, the plurality of numerical operations comprises learned and neural network operations in step 2682, on the arbitrary input data in the internal format;
c. transforms the arbitrary input data into output data having output formats using a reciprocal process learned to transform the output data from the arbitrary input data in Step 2683; all steps being done unsupervised and do not use hand-labeled data; and
d. feeding the outputs of the excitatory-inhibitory network into the leaf nodes of the HAN network, as time-series basis coordinates to each leaf node, with the HAN network transforming those into engrams then output data in real-life format in step 2684. All steps being done unsupervised and do not use hand-labeled data

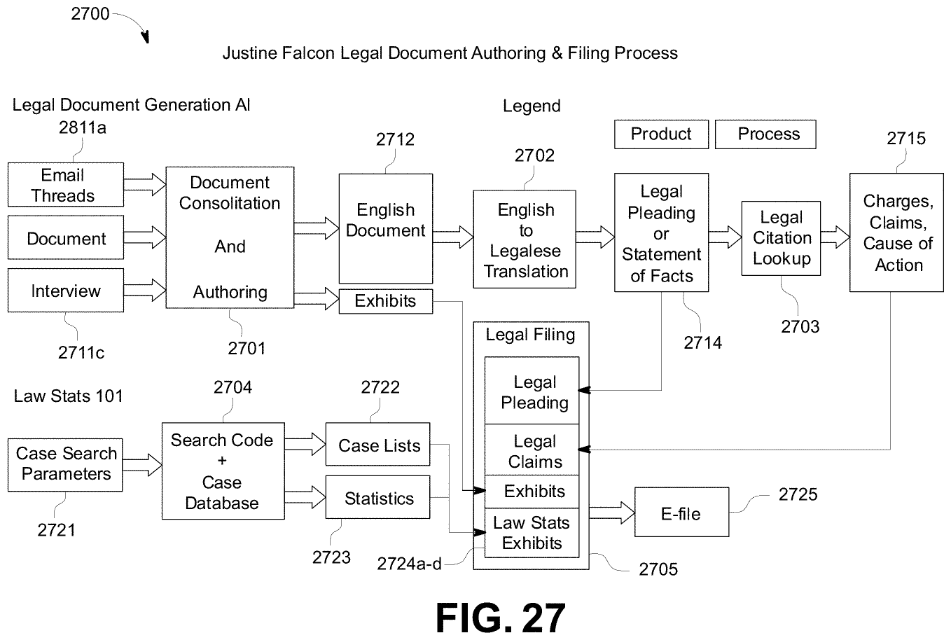

FIG. 27 illustrates a usage of a system for providing artificial intelligence using neural networks and other computer hardware and software devices and methods to simulate human intelligence according to the present technology. For the detailed embodiment of the present technology, an embodiment of the AGI present technology able to practice law and litigate is disclosed. Law, when broken down into its most basic elements, is a conversation between two sides, with each attorney submitting their filings in a sequence similar to our conversation AGI. However in law, the format of the conversation, the filings, and the legal language are more constrained, sometimes even boilerplate or even forms, and this actually makes it easier for an AGI to learn law than normal language and easier than interpreting the real world.

First, the present technology builds the AGI itself. Most of the components in the AGI are not coded, nor designed by hand, but rather evolved in the process described herein and in Utility patent U.S. Ser. No. 16/437,838, by genetic algorithms. Where traditional deep neural nets are simply constructed by coding the network structure and training it on static data sets, the AGI components are specified by a genome, first generated by hand or an automated process of the designer's choosing, then expanded to a SNN by a deterministic process, that is well described in U.S. Utility patent application Ser. No. 16/437,838, hereafter referred to as NeuroCAD.

The designer first comes up with a selection criteria. For example, an autoencoder disclosed in FIGS. 3-4 that encodes any form of data, say in this case, text characters as black and white images, has the selection criteria that the decoded image must match the encoded image, with how closely it matches being determined by a mathematical comparison of each pixel, computing the difference between the images by summation of the absolute or square values at each pixel doing a root mean square calculation. This selection criteria are then used in the subsequent genetic algorithms.

Now the designer must ‘seed’ the genetic algorithm by giving it 2 or more starting genomes to begin with, the present technology will say N genomes. These starting genomes may be designed by hand using the tools and methods described in the NeuroCAD patent, or they may be generated by any mathematical algorithm (random or otherwise) that is constrained to produce a valid genome and connectome, or they may be obtained from third parties that developed these genomes for other applications.

Once N genomes have been designed, they are saved out as files on the NeuroCAD host computer, and then they are crossbred in a process where for each pair of genomes (m,n) where (0<=m<N) and (0<=n<N) are crossbred in an operation defined in NeuroCAD, and a genome based on them is output from this process until there are N×N genome files.

The dataset to train on is uploaded to a server, and for each of the N×N NeuroCAD genome files, each one is uploaded to a server or workstation computer and for each one an instance of the NeuroCAD simulation is executed, with the path to the data (on the data server), and the name of the genome file (on the local server) as parameters. NeuroCAD loads the genome file, expands it to a connectome by the process described in the NeuroCAD patent, and then loads the data file, in this case a series of text images consisting of letters, and presents each image to the top layer of the neural network, sampling the pixels to the neurons under it to be resolution independent, and computes the amount of current delivered to each neuron as the sum of the pixel values above it, multiplied by a gain factor.

The simulation runs as per the NeuroCAD patent, with the SNN doing computations while images are delivered to the top layer in sequence with the timing interval specified in the genome as disclosed in reference FIG. 5. Input comes in at layer 0, is encoded through the encoder into the bottom layer(s), where it is forced into a constrained bottleneck, and then decoded back through the feedback circuits of the autoencoder to layer 1, which is fed back into the even layers to generate a training feedback loop. After the simulation has run through the data for a certain number of epochs, or loops through all the data, specified by the user at launch, the images at layer 0 and 1 are subjected to the performance criteria as in U.S. patent application Ser. No. 16/437,838 for the final epoch, and an averaged result used to compute a performance score for that genome, which is sent back to the NeuroCAD host computer.

The NeuroCAD host computer then compares the performance score for the genomes, selects the top N, and again crossbreeds them to create N×N genomes, which are subjected to the same process disclosed above until the top score exceeds a threshold set by the designer, or times out after a specified number of generations of genetic algorithms has been reached by the NeuroCAD process.

The present technology trains other components, such as the predictor SNN 2300 in a similar manner with the NeuroCAD tools, except this time the inputs to the predictor are time-series data where the input samples in time are from the past (t<t0), and outputs are time-series data with the sample points in the ‘future’. The present technology has to train and evolve this on a data set where the actual ‘past’ and ‘future’ are both known, relative to t0, so the present technology uses data from the past and increments t0, measuring the deviation between the predicted ‘future’ and actual ‘future,’ measured as the sum of the squares of the differences between the predicted data points for each t0 and the actual future data points. The sum of all these errors is computed for the prediction sequence for all of the data (tN<t0<tM), and the selection criteria is to minimize the prediction error. Again, the methods for NeuroCAD genetic algorithms are used to refine the design by successive generations and crossbreeding.

A component is called a ‘dreamer’ by the present technology which is simply trained as a predictor but in operation uses both input data from the real world and/or its own output of future predictions as its subsequent input. This approach allows it to start predicting on known data, then once that data ends it can simulate future data series by ‘dreaming’ from its output, where there is no input data past a certain point. The SNNs is doing this prediction by starting small, with a few important inputs, and evolves into massive SNNs with enormous amounts of detailed training data both in time and in breadth and variety, the present technology can accurately predict the future behavior of complex systems, people, and groups of people.

Now the present technology begins by using images of text transformed into ASCII, then into the internal HTSIS format. In training, the AI system 100 scans each letter on the page left to right, top to bottom. The Engram that is encoded is added to the Engram stream for this document, and Engrams are buffered up until that buffer reaches a maximum size. Then it begins submitting sequential Engrams to the HAN, and each Engram is processed with PCA axes training to divide the Engrams by different features and autoencoders training to encode the groups with similar features on each axis as disclosed in reference to FIG. 15a. Again the HAN is trained and evolved by having it process a data set of documents and measuring it on performance In this case, the performance criteria are does it produce an alphanumeric basis set and can it identify written letters and numbers correctly. The number of errors made on a training data set are the performance metric, and the genome represents the number and configuration of autoencoders and axes.

Once a suitably trained and evolved HAN network is complete, in operation the AI scans each letter on the page left to right, top to bottom each Engram that is encoded is added to the Engram stream for this document, and Engrams are buffered up until that buffer reaches a maximum size. Then it begins submitting sequential Engrams to the HAN network, and each Engram is processed according to the process disclosed in FIG. 15a with PCA axes training to divide the Engrams by different features and autoencoders training to encode the groups with similar features on each axis. See FIG. 15a. The output is the basis coordinate for each of the ASCII characters, which should now be 1.0 for the character in the text image.

The present technology can now use paper documents including emails 2711a, documents 2711b, and interviews 2711c, which are scanned by this algorithm, or just straight ASCII text from digital documents to provide input for both training and for the operation of a simple litigation predictor AI. A document compilation and authoring process 2701 separates the data into English documents 2712 and exhibits 2713. The English documents 2712 are submitted to an English-to-Legalese translation process 2702 which generates legal pleadings and statements of fact 2714. The legal pleadings may be used by a legal citation lookup process 2703 to generate recommended charges, claims and causes of action 2715 relevant to the facts. The legal pleadings and statements of fact 2714 are also added to a legal filing process 2705 that organizes the material into relevant components including legal pleadings legal claims, exhibits, and law statistics exhibits 2724a-d.

At the same time that the documents are processed above, a search code and case database process 2707 accepts case search parameters 2721 to generate case lists 2722 and statistics associated with the parties, the attorneys, and the court officers. This data 2722-2723 is added to the legal filing process 2705 for use in any cases. The legal filing process 2705 also may generate and electronically filed 2725 pleadings and exhibits with a court as appropriate.

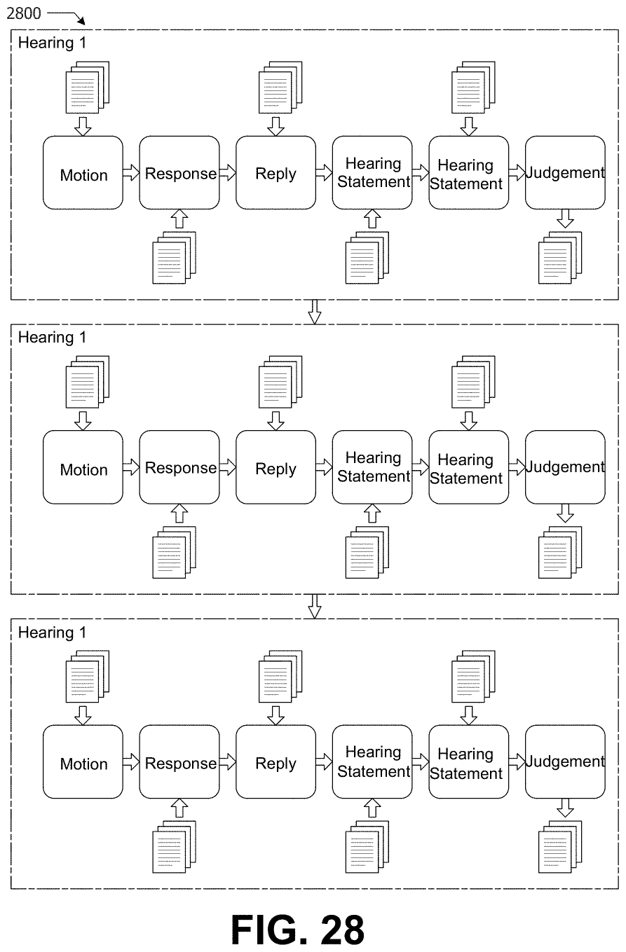

Results generated give our legal AI the ability to predict the next actions of the opposing counsel, by using the same conversational AI example as disclosed in FIG. 28, except this time the conversation has a fixed format, with a series of hearings, each being a sequence of filings or documents: motion (plaintiff)->opposition(defendant)->reply(plaintiff)->decision (judge). This time it is a 3 way conversation, with the plaintiff, defendant, and judge, so it is more complex to model.

FIG. 28 illustrates the above sequence of operations 2800 to use a predictor 2300 that predicts the sequence of hearings in the proceeding. Each proceeding in California US State family and civil court has a downloadable pdf consisting of all the hearings 2801-2803 that took place and the types of event, usually filings by each side. This information is encoded in symbolic text and plain language wording, and there are only a few dozen types of hearings and events for a given court proceeding, so this is a perfect place to use a predictor on this very constrained vocabulary of phrases and sentences.

Predictors disclosed above are trained on the HTSIS word sequences from each event and hearing. Users of the present technology provide the list of hearings as input and train the 1st predictor to sample the text in the last N events in the history of the proceeding as input and to train on what the next event by the Plaintiff is as the output, then the present technology trains the 2nd predictor on the same input data but trains it on the next event by the defendant as output. A third predictor is trained on the same input data, but with the next action by the judge as output.

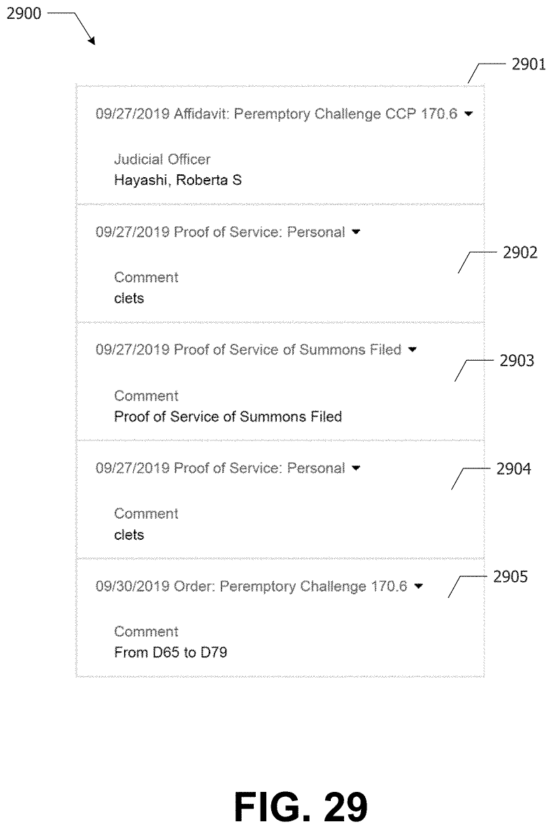

Now the present technology has 3 predictors, each trained to look at the last N events in a court proceeding 2801-2803 and predict what the next action by the plaintiff will be, what the next action by the defendant will be, and how a judge is likely to rule. This process may seem naive to try to do this with such little data, but it would be surprising to those not versed in law and litigation that the content of the filings matters less than the who are the lawyers filing them (most filings are boilerplate, and done the same in every case by the lawyer), and who is the judge presiding over the proceeding, as judges are known to rule in very similar ways in similar cases, and many judges barely even bother to read most of the filings if simply because of available time. What the present technology is predicting is the humans in the equation, which are surprisingly very predictable. FIG. 29 illustrates documents and material 2901-2905 resulting from the above process.

Now this embodiment of the present technology makes predictions in the proceeding, treating it as a conversation where users have conversations consisting of descriptions of filings by each side, then a judgement. Sometimes in a hearing there may be more filings by one or more of the participants, but this is the standard (Motion—Opposition—Reply—Judgement) format, with one or more verbal arguments by each side during the hearing, which can be ignored because the judge has already made up his/her mind. The present technology generates the prediction of the plaintiff's next filing, and the present technology gets output of what the defendant is going to file, or what the judge will order. The present technology is now a tool that can allow us to predict the outcome of a filing.

The present technology can extend this by making the AI dream once trained and have the two predictors and our actual future filings fed into the AI, advancing a simulated proceeding step by step into the future, to see how the case could unfold in reaction to our filings along the way, like a chess program predicts its opponent 4-5 moves into the future. Many of these chess programs cannot be beaten by a human.

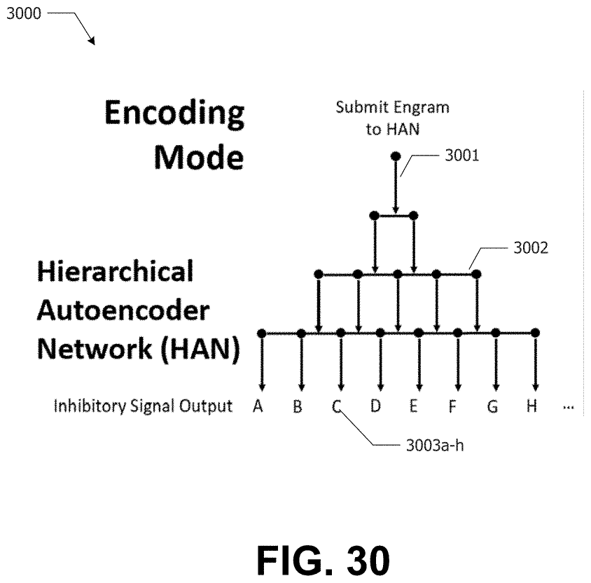

FIG. 30 illustrates how to use the HAN network in combination with the ROS-I to learn whole documents, and is disclosed using their paragraph rules of composition, sentence grammar, and spelling according to the present technology. The HAN network learns the spatial component of inputs, separating them into Engram basis sets that can help identify letters in text, and phonemes in speech. Now the present technology uses the ROS-I network to learn the temporal component of language, forming words, sentences, and paragraphs.

The embodiments described herein are implemented as logical operations performed by a computer. The logical operations of these various embodiments of the present technology are implemented (1) as a sequence of computer-implemented steps or program modules running on a computing system and/or (2) as interconnected machine modules or hardware logic within the computing system. The implementation is a matter of choice dependent on the performance requirements of the computing system implementing the present technology. Accordingly, the logical operations making up the embodiments of the present technology described herein can be variously referred to as operations, steps, or modules In order to provide functionality according to some other embodiments, such steps, processes or methods may be performed in different orders than those described and illustrated in the drawings and one or more steps, processes or methods may be omitted.

Even though particular combinations of features are recited in the present application, these combinations are not intended to limit the disclosure of the invention. In fact, many of these features may be combined in ways not specifically recited in this application. In other words, any of the features mentioned in this application may be included in this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise. Any singular term used in this present patent application is applicable to its plural form even if the singular form of any term is used.

In the present application, all or any part of the present techology's-software or application(s) of the present technology may be installed on any of the user's or operator's smart device(s), any server(s) or computer system(s) or web application(s) required to allow communication, control (including but not limited to control of parameters, settings such as for example, sign copy brightness, contrast, ambient light sensor settings . . . etc.), transfer of content(s) or data between any combination of the components.

We claim:

1. A method for artificial general intelligence that can simulate human intelligence, implemented by taking in any form of arbitrary input data, the method comprising:
learning to transform the arbitrary input data into an internal numerical format;
performing a plurality of numerical operations, the plurality of numerical operations comprises learned and neural network operations, on the arbitrary input data in the internal format; and
transforming the arbitrary input data into output data having output formats using a reciprocal process learned to transform the output data from the arbitrary input data;
wherein all steps being done unsupervised.

2. The method according to claim 1, wherein the learning to transform step comprising:
utilizing an autoencoder that learns to encode the arbitrary input data into a compact engram stream; and
decoding the compact engram stream, with the engram stream being sampled from a volume at a bottleneck of the autoencoder.

3. The method according to claim 2, wherein the learning to transform step further comprising:
subdividing the engram stream into segments in time, and the resulting engram segments are passed down a branching hierarchy having leaf nodes, the branching hierarchy being a Hierarchical Autoencoder Network (HAN network), the HAN network subdividing the engram segments by features until the leaf nodes of the HAN network are each unique, sharing no common features, and forming an orthogonal basis set of engram vectors having a plurality of axes.

4. The method according to claim 3, wherein the subdividing the engram stream step further comprising:
sorting the engram segments by alternately performing principal component analysis along an axis by a specific feature;
autoencoding each cluster on each of the axes, thereby removing the common features of the cluster; and
passing the new encoded engrams down the HAN network to perform principal component analysis to sort the new encoded engrams along new axes by new features until the leaf nodes of the HAN network are each unique and form an orthogonal basis set of engram vectors.

5. The method according to claim 4, wherein the learning to transform step further comprising:
using the orthogonal basis set and the HAN network to transform from the arbitrary Input data to engram segments; and
traversing the hierarchy to the leaf nodes and convolving the engram segment with the engram basis vectors of each leaf node to generate time-series basis coordinates, where each coordinate represents the convolution product of the engram segment and engram basis vector; and
processing the time-series basis coordinates in reverse transforming the basis coordinates of the engram segments into the arbitrary outputs by multiplying the basis coordinate by the basis engram and decoding it upwards through the hierarchy.

6. The method according to claim 1, wherein the performing a plurality of numerical operations step comprising:
performing computations on the time-series basis coordinates of numerical coefficient vectors, where a plurality of input vectors from given times (ti) on a plurality of memory narratives are used as inputs to the computation to produce a plurality of output vectors to a plurality of the time-series basis coordinates.

7. The method according to claim 6, wherein the performing a plurality of numerical and other learned operations step further comprising:
performing a predictor where a plurality of input basis coordinates from past times (t−N, . . . t−2, t−1, t) from a plurality of the time-series basis coordinates are used as inputs, and a model trained on real past data is used to generate a plurality of output vectors, set in a future time.

8. The method according to claim 7, wherein the performing a predictor step further comprises subsequently using the output from the predictor with input from the time-series basis coordinates as the input to said predictor, such that it is simulating reality to create output time-series basis coordinates based on the model.

10. The method according to claim 5, wherein the learning to transform step further comprising:
training a ROS-Inhibitory neural network (ROS-I network), a detailed sequential time-space outputs, using an artificial neural network with a linear component that generates a propagating linear signal, and networks that branch off that linear component that transmit that signal down the branching network and modulate it with inhibitory signals.

11. The method according to claim 10, wherein the training a ROS-I network step further comprising:
creating a sequence of excitatory artificial neurons to create a linear pulse chain, each of these excitatory artificial neurons has a plurality of branching neural nets of inhibitory artificial neurons emanating from it; and
propagating a signal from the excitatory neurons propagates down the branching neural networks.

12. The method as in 11, wherein creating a sequence of excitatory artificial neurons step further comprising:
controlling by a unique external input signal each inhibitory artificial neuron causing the inhibitory artificial neuron to modulate the signal from the artificial neurons above it in the hierarchy with the inhibitory signal.

13. The method according to claim 12, wherein learning to transform the arbitrary input data step further comprising:
controlling each inhibitory control signal to large sections of the inhibitory networks downstream of its inhibitory artificial neuron; and
generating complex spatial-temporal signals when combined with the excitatory signal for sequential functions like motor control, language.

14. The method according to claim 13, wherein the training the ROS-I network step further comprising:
back-driving the complex spatial-temporal signals through the ROS-I network with the desired output, such as for motor control or language to train the inhibitory signals to reproduce the complex spatial-temporal signals.

15. The method according to claim 14, the transforming the arbitrary input data further comprising feeding the outputs of the excitatory-inhibitory network into the leaf nodes of the HAN, as time-series basis coordinates to each leaf node, with the HAN transforming those into engrams then output data in real-life format.

16. An artificial general intelligence system for computer simulations of Artificial General Intelligence (AGI) are able to operate on general inputs and outputs that do not have to be specifically formatted, nor labelled by humans and can consist of any alpha-numerical data stream, the artificial general intelligence system comprising:
a memory having instructions stored thereon;
a short term memory;
a long term memory;
a Hierarchical Autoencoder Network (HAN network);
a ROS-Inhibitory neural network (ROS-I network), the ROS-I network having inhibitor signals; and
a processor configured to execute the instructions on the memory to cause the electronic apparatus to:
learn to transform the arbitrary input data into an internal numerical format;
perform a plurality of numerical and other learned operations on the arbitrary input data in the internal format; and
transform the arbitrary input data into output data having output formats using a reciprocal process learned to transform the output data from the arbitrary input data;
wherein transforming the arbitrary input data step further comprising feeding the outputs of the excitatory-inhibitory network into the leaf nodes of the HAN network, as time-series basis coordinates to each leaf node, with the HAN network transforming those into engrams then output data in real-life format; and
wherein all steps being done unsupervised.

17. The artificial general intelligence system according to claim 16, wherein the learning to transform the arbitrary input data step further comprising:
utilizing an autoencoder that learns to encode the arbitrary input data into a compact engram stream;
decoding the compact engram stream, with the engram stream being sampled from a volume at a bottleneck of the autoencoder;
subdividing the engram stream into segments in time, and the resulting engram segments are passed down a branching hierarchy having leaf nodes, the branching hierarchy being a Hierarchical Autoencoder Network (HAN network), the HAN network subdividing the engram segments by features until the leaf nodes of the HAN network are each unique, sharing no common features, and forming an orthogonal basis set of engram vectors having a plurality of axes;
sorting the engram segments by alternately performing principal component analysis along an axis by a specific feature;
autoencoding each cluster on each of the axes, thereby removing the common features of the cluster;
passing the new encoded engrams down the HAN network to perform principal component analysis to sort the new encoded engrams along new axes by new features until the leaf nodes of the HAN network are each unique and form an orthogonal basis set of engram vectors;
using the orthogonal basis set and the HAN network to transform from the arbitrary Input data to engram segments;
traversing the hierarchy to the leaf nodes and convolving the engram segment with the engram basis vectors of each leaf node to generate time-series basis coordinates, where each coordinate represents the convolution product of the engram segment and engram basis vector; and
training a ROS-Inhibitory neural network (ROS-I network), a detailed sequential time-space outputs, using an artificial neural network with a linear component that generates a propagating linear signal, and networks that branch off that linear component that transmit that signal down the branching network and modulate it with inhibitory signals.

18. The artificial general intelligence system according to claim 17, wherein the performing a plurality of numerical operations, the plurality of numerical operations comprises learned and neural network operations, on the arbitrary input data in the internal format comprising:
processing the time-series basis coordinates in reverse to transforming the basis coordinates of the engram segments into the arbitrary outputs, performing computations on the time-series basis coordinates of numerical coefficient vectors, where a plurality of input vectors from given times (t) on a plurality of the time-series basis coordinates are used as inputs to the computation to produce a plurality of output vectors to a plurality of the time-series basis coordinates;
subsequently using the output from the predictor with input from the time-series basis coordinates as the input to said predictor, such that it is simulating reality to create output time-series basis coordinates based on the model;
creating a sequence of excitatory artificial neurons to create a linear pulse chain, each of these excitatory artificial neurons has a plurality of branching neural nets of inhibitory artificial neurons emanating from it; and
propagating a signal from the excitatory neurons propagates down the branching neural networks.

19. A non-transitory computer-readable recording medium in a computing device for computer simulations of Artificial General Intelligence (AGI) able to operate on arbitrary general inputs and outputs consisting of any alpha-numerical data stream by a computing device, the computing device configured to accept unstructured audio and sequential images, the non-transitory computer-readable recording medium storing one or more programs which when executed by the computing device performs steps comprising:
learning to transform the arbitrary input data into an internal numerical format comprising:
utilizing an autoencoder that learns to encode the arbitrary input data into a compact engram stream;
decoding the compact engram stream, with the engram stream being sampled from a volume at a bottleneck of the autoencoder;
subdividing the engram stream into segments in time, and the resulting engram segments are passed down a branching hierarchy having leaf nodes, the branching hierarchy being a Hierarchical Autoencoder Network (HAN network), the HAN network subdividing the engram segments by features until the leaf nodes of the HAN network are each unique, sharing no common features, and forming an orthogonal basis set of engram vectors having a plurality of axes;
sorting the engram segments by alternately performing principal component analysis along an axis by a specific feature;
autoencoding each cluster on each of the axes, thereby removing the common features of the cluster;
passing the new encoded engrams down the HAN network to perform principal component analysis to sort the new encoded engrams along new axes by new features until the leaf nodes of the HAN network are each unique and form an orthogonal basis set of engram vectors;
using the orthogonal basis set and the HAN network to transform from the arbitrary Input data to engram segments;
traversing the hierarchy to the leaf nodes and convolving the engram segment with the engram basis vectors of each leaf node to generate time-series basis coordinates, where each coordinate represents the convolution product of the engram segment and engram basis vector; and
training a ROS-Inhibitory neural network (ROS-I network), a detailed sequential time-space outputs, using an artificial neural network with a linear component that generates a propagating linear signal, and networks that branch off that linear component that transmit that signal down the branching network and modulate it with inhibitory signals;
performing a plurality of numerical and other learned operations on the arbitrary input data in the internal format comprising:
processing the time-series basis coordinates in reverse transforming the basis coordinates of the engram segments into the arbitrary outputs, performing computations on the time-series basis coordinates of numerical coefficient vectors, where a plurality of input vectors from given times (t) on a plurality of the time-series basis coordinates are used as inputs to the computation to produce a plurality of output vectors to a plurality of the time-series basis coordinates;
subsequently using the output from the predictor with input from the time-series basis coordinates as the input to said predictor, such that it is simulating reality to create output time-series basis coordinates based on the model; creating a sequence of excitatory artificial neurons to create a linear pulse chain, each of these excitatory artificial neurons has a plurality of branching neural nets of inhibitory artificial neurons emanating from it; and
propagating a signal from the excitatory neurons propagates down the branching neural networks; and
transforming the arbitrary input data into output data having output formats using a reciprocal process learned to transform the output data from the arbitrary input data;
wherein all steps being done unsupervised.

20. The non-transitory computer-readable recording medium according to claim 19, wherein transforming the arbitrary input data step further comprising feeding the outputs of the excitatory-inhibitory network into the leaf nodes of the HAN network, as time-series basis coordinates to each leaf node, with the HAN network transforming those into engrams then output data in real-life format.
